(19) United States
(12) Patent Application Publication
(10) Pub. No.: US 2025/0013341 A1
(43) Pub. Date: Jan. 9, 2025

(54) SYSTEMS AND METHODS FOR DETERMINING AND QUANTIFYING IMAGE DATA

(71) Applicant: Gauss Labs Inc., Palo Alto, CA (US)

(72) Inventors: Yonghyun Kim, Seongam-si (KR); Ilkoo Kim, Seongam-si (KR); Hoon Byun, Gunpo-si (KR); Wonhui Park, Suwon-si (KR); Sang-gil Park, Seoul (KR)

(21) Appl. No.: 18/756,287

(22) Filed: Jun. 27, 2024

Related U.S. Application Data
(60) Provisional application No. 63/590,941, filed on Oct. 17, 2023.
(60) Provisional application No. 63/512,532, filed on Jul. 7, 2023.

(51) Int. Cl. G06F 3/0481; G06T 7/00

(52) U.S. Cl. CPC G06F 3/0481; G06T 7/0004; G06T 2207/30148

(57) ABSTRACT

Systems and methods for detecting and quantifying images are disclosed. Systems and methods can include a metrology platform comprising: a customizable or user-configurable pipeline that is configured to enable a user to automatically and longitudinally obtain a plurality of metrology metrics from a process environment; and a graphical user interface (GUI) for implementing the pipeline, wherein the GUI comprises (1) a plurality of graphical functions configured to permit the user to interact with or to customize the pipeline and (2) one or more visual display areas configured to display the plurality of metrology metrics and a set of metrology images associated thereof.

### CROSS-REFERENCE TO RELATED APPLICATIONS

This application claims the benefit of U.S. Provisional Application No. 63/512,532, filed Jul. 7, 2023, and U.S. Provisional Application No. 63/590,941, filed Oct. 17, 2023, each of which is incorporated by reference herein in its entirety.

### BACKGROUND

In metrology within the semiconductor manufacturing field, accurately measuring semiconductor structures has been challenging due to complexities in defining effective measurement points and methodologies. An engineer often has to manually pinpoint the exact locations for measurement. Even defining measurement methodologies for hundreds of metrics in semiconductor production can take weeks or longer. Furthermore, due to the ambiguities in the shape of semiconductor structures, measurements are often limited to calculations on small and specific ranges rather than recognizing and measuring the object's overall structure. As a result, many measurements are limited by an engineer's knowledge, resulting in a mere fraction of possible measurements and sometimes missing crucial information helpful for yield improvement.

### SUMMARY

The disclosed technology includes an augmented metrology tool that can facilitate effective measurement and analysis of various semiconductor structures within various semiconductor images, underscored by robust automation and user customization. Compared to other metrology approaches, the augmented metrology tool disclosed herein can augment typical approaches by: determining or defining all metrics or important metrics with minimal user interaction; using advanced metrology methods to ensure stable measurements even for objects that are difficult to automate; using advanced analysis methods, including machine learning, to determine or generate metrics that improve yield; and using automation and customization to define measurement and analysis methods as a pipeline that are customized to individual users.

The augmented metrology tool offers systems and methods in semiconductor measurement designed to overcome industry challenges by providing advanced automation and customization capabilities with minimal user interaction in semiconductor image metrology. The augmented metrology tool comprises features of user support, the design of user interfaces (UIs), and system architectures that effectively realizes such support to users. The augmented metrology tool allows users to obtain hundreds to thousands of metrics automatically in a second. The augmented metrology tool includes a comprehensive analysis tool that highlights critical metrics, which enables users to analyze a plurality of metrics effectively. Moreover, the augmented metrology tool offers features to analyze the relationship between, e.g., yield and the metrics by tracking the manufacturing process. The user can easily select the essential metrics which have a high impact to yield and manage them to increase the overall yield of semiconductor manufacturing processes and products.

The augmented metrology tool can enable a system to meticulously measure hundreds to tens of thousands of metrics in mere minutes or less. One of the significant drawbacks of other systems is an inability to respond when challenging or new semiconductor processes are introduced. This limitation is mitigated or overcome through the disclosed customization tools.

Significant improvements are expected in various stages of semiconductor production. For instance, in the research and development stage, the augmented metrology tool can make it easier to measure ambiguous objects, and the speed and quality of research are significantly improved. In the production stage, the augmented metrology tool can allow quick implementation and improvements for yield improvement by not omitting any metrics or important metrics that can affect yield.

In an aspect, disclosed herein is a metrology platform comprising: a customizable or user-configurable pipeline that is configured to enable a user to automatically and longitudinally obtain a plurality of metrology metrics from a process environment; and a graphical user interface (GUI) for implementing the pipeline, wherein the GUI comprises (1) a plurality of graphical functions configured to permit the user to interact with or to customize the pipeline and (2) one or more visual display areas configured to display the plurality of metrology metrics and a set of metrology images associated thereof.

In some embodiments, the plurality of metrology metrics are associated with a plurality of processing steps and/or equipment in the process environment.

In some embodiments, the plurality of metrology metrics comprise at least 100 metrology metrics.

In some embodiments, the plurality of metrology metrics comprise at least 1000 metrology metrics.

In some embodiments, the platform is configured to enable the user to obtain the plurality of metrology metrics from the process environment in a time duration of less than about 5 minutes.

In some embodiments, the platform is configured to enable the user to obtain the plurality of metrology metrics from the process environment in a time duration of less than about 1 minute.

In some embodiments, the one or more visual display areas are configured to dynamically update the plurality of metrology metrics and the set of metrology images substantially in realtime, as the user is interacting with or customizing the pipeline using the plurality of graphical functions.

In some embodiments, the process environment comprises a semiconductor manufacturing environment.

In some embodiments, the pipeline is configured to incorporate (1) one or more new processes and/or (2) one or more changes to existing processes that are introduced into the process environment.

In some embodiments, the GUI is configured to permit the user to define one or more objects of interest from the set of metrology images.

In some embodiments, the one or more objects of interest comprise a deposited or fabricated structure that is formed in the process environment.

In some embodiments, the plurality of metrology metrics comprise a plurality of critical dimensions (CDs) of the one or more objects of interest.

In some embodiments, the set of metrology images is collected from the process environment.

In some embodiments, the set of metrology images comprises scanning electron microscopy (SEM) images, transmission electron microscopy (TEM) images, and/or reflection electron microscopy (REM) images.

In some embodiments, the pipeline is configured to automatically analyze one or more objects of interest defined by the user through the GUI.

In some embodiments, the pipeline is configured to automatically locate and copy definitions for two or more similar objects of interest.

In some embodiments, the pipeline is configured to dynamically modify a metrology result by tuning one or more measurement methods based at least in part on a set of requirements that the user provides via the GUI.

In some embodiments, the pipeline is configured to receive an input from the user through the GUI, wherein the input is used to define one or more objects of interest when an automatic or default definition for the one or more objects is unavailable.

In some embodiments, the pipeline is configured to automatically derive the plurality of metrics for one or more objects of interest to the user, based at least in part on definitions associated with the one or more objects.

In some embodiments, wherein the pipeline is configured to automatically modify relationships between the plurality of metrics and one or more objects of interest to the user, without requiring input from the user through the GUI.

In some embodiments, the pipeline is configured to modify relationships between the plurality of metrics and one or more objects of interest to the user, based at least in part on input received from the user through the GUI.

In some embodiments, the pipeline is configured to accept definitions of one or more metrology measurement methods.

In some embodiments, the GUI is configured to allow the user to add one or more stages to the pipeline.

In some embodiments, the GUI is configured to allow the user to remove one or more stages from the pipeline.

In some embodiments, the GUI is configured to allow the user to remove modify one or more hyperparameters in the pipeline.

In some embodiments, the GUI is configured to allow the user to customize one or more stages in the pipeline.

In some embodiments, the GUI is configured to allow the user to modify one or more elements associated with object measurement and analysis.

In some embodiments, the pipeline comprises a dataflow module configured to manage system input/output (IO) through the GUI, wherein the GUI comprises a plurality of options that enable the user to connect the user's system to the pipeline.

In some embodiments, the plurality of options comprises a synchronization option, a source option, a destination option, and a transformer option.

In some embodiments, the synchronization option is configured to define triggering of a workflow in the pipeline.

In some embodiments, the source option is configured to define an input source for the user's system and the pipeline.

In some embodiments, the destination option is configured to define an output source for the user's system and the pipeline.

In some embodiments, the transformer option is configured to specify a modification to data received from the input source before saving modified data to a destination.

In some embodiments, the modification comprises changing a file name, changing a folder structure, or adding a new metafile.

In some embodiments, the GUI permits the user to select a frequency of data synchronization from one of the following: stream, daily, manual, or passive.

In some embodiments, the GUI is configured to enable the user to add one or more custom components to each of the plurality of options, and/or remove one or more components from each of the plurality of options.

In some embodiments, the GUI comprises a dashboard comprising a plurality of panels that display information about the user's system and the pipeline.

In some embodiments, the information comprises a resource status.

In some embodiments, the information comprises pipeline workflow run successes or failures.

In some embodiments, the GUI is configured to enable the user to modify the dashboard by adding a new panel and/or removing an existing panel.

In some embodiments, the GUI is configured to enable the user to adjust a size and/or position of one or more panels on the dashboard.

In some embodiments, the metrology platform further comprises an analysis module configured to analyze a distribution or correlation with yield among the plurality of metrics.

In some embodiments, the distribution or correlation is analyzed within the set of metrology images and datasets for a single domain within the process environment.

In some embodiments, the distribution or correlation is analyzed between or across multiple sets of metrology images and datasets for multiple domains within the process environment.

In some embodiments, the analysis module is configured to recommend a set of metrics from the plurality of metrics to the user, based at least in part on an analysis of the distribution or correlation with yield among the plurality of metrics.

In some embodiments, the GUI is configured to display the recommended set of metrics.

In some embodiments, the analysis module is configured to provide an analysis of a correlation between yield and various levels, from individual objects in metrology images to a process within the process environment.

In some embodiments, the analysis comprises generating a score indicative of the correlation.

In some embodiments, the analysis further comprises generating a score interval at one or more confidence levels.

In some embodiments, the metrology platform further comprises an anomaly analysis module configured to provide anomaly information likely to impact metrology measurements.

In some embodiments, the anomaly information comprises object anomalies that indicate a presence and/or transformed state of one or more objects in one or more metrology images.

In some embodiments, the anomaly information comprises one or more types of object anomalies.

In some embodiments, the anomaly information is provided in a report displayed on the GUI, and wherein the report is useable for analyzing process stability or issues.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

The novel features of the disclosure are set forth with particularity in the appended claims.

A better understanding of the features and advantages of the present disclosure will be obtained by reference to the following detailed description that sets forth illustrative embodiments, in which the principles of the disclosure are utilized, and the accompanying drawings of which:

FIG. 1 shows an example screenshot of the user interface of the augmented metrology tool, in accordance with some embodiments;

FIG. 2 shows an example screenshot of the user interface of a pipeline configuration page, in accordance with some embodiments;

FIGS. 3, 4, and 5 each show an example screenshot of the user interface of an object configuration tool, in accordance with some embodiments;

FIGS. 6, 7, 8, and 9 each show an example screenshot of the user interface of an object analytic tool, in accordance with some embodiments;

FIGS. 10-11 each show an example screenshot of the user interface of an object duplication tool, in accordance with some embodiments;

FIGS. 12-13 each show an example screenshot of the user interface of the object configuration page, in accordance with some embodiments;

FIGS. 14-15 each show an example screenshot of the user interface of the metrics editor page, in accordance with some embodiments;

FIGS. 16-17 each show an example screenshot of the user interface of the PipelineRuns page, in accordance with some embodiments;

FIGS. 18, 19, and 20 each show an example screenshot of the user interface of the Datasets page, in accordance with some embodiments;

FIGS. 21, 22, 23, and 24 each show an example screenshot of the user interface of the Analysis page, in accordance with some embodiments;

FIG. 25 shows a set of example images with objects that have been annotated by the user and detected by the augmented metrology tool, in accordance with some embodiments;

FIG. 26 shows an example screenshot of the user interface of the Metrics Builder, in accordance with some embodiments;

FIGS. 27, 28, and 29 each show an example screenshot of the user interface of the Dashboard page, in accordance with some embodiments;

FIG. 30 shows an example of a screenshot of a dataflow user interface, in accordance with some embodiments;

FIG. 31 shows an example of screenshot of a platform or systems overview user interface, in accordance with some embodiments;

FIGS. 32A-32B show an example high-level system architecture diagram of the augmented metrology tool and a pipeline, in accordance with some embodiments;

FIG. 33 shows a non-limiting example of a computing device; in this case, a device with one or more processors, memory, storage, and a network interface, in accordance with some embodiments;

FIG. 34 shows a non-limiting example of a web/mobile application provision system; in this case, a system providing browser-based and/or native mobile user interfaces, in accordance with some embodiments; and

FIG. 35 shows a non-limiting example of a cloud-based web/mobile application provision system; in this case, a system comprising an elastically load balanced, auto-scaling web server and application server resources as well synchronously replicated databases, in accordance with some embodiments.

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

In an aspect, disclosed herein is a metrology platform comprising: a customizable or user-configurable pipeline that is configured to enable a user to automatically and longitudinally obtain a plurality of metrology metrics from a process environment; and a graphical user interface (GUI) for implementing the pipeline, wherein the GUI comprises (1) a plurality of graphical functions configured to permit the user to interact with or to customize the pipeline and (2) one or more visual display areas configured to display the plurality of metrology metrics and a set of metrology images associated thereof. In some embodiments, the process environment comprises a semiconductor manufacturing environment. In some embodiments, the pipeline is configured to incorporate (1) one or more new processes and/or (2) one or more changes to existing processes that are introduced into the process environment.

### Pipelines

In some embodiments, the pipeline is configured to automatically analyze one or more objects of interest defined by the user through the GUI. In some embodiments, the pipeline is configured to automatically analyze one or more objects of interest defined by the user through the GUI.

In some embodiments, the pipeline is configured to automatically locate and copy definitions for two or more similar objects of interest. In some embodiments, the pipeline is configured to dynamically modify a metrology result by tuning one or more measurement methods based at least in part on a set of requirements that the user provides via the GUI. In some embodiments, the pipeline is configured to receive an input from the user through the GUI, wherein the input is used to define one or more objects of interest when an automatic or default definition for the one or more objects is unavailable. In some embodiments, the pipeline is configured to automatically derive the plurality of metrics for one or more objects of interest to the user, based at least in part on definitions associated with the one or more objects. In some embodiments, wherein the pipeline is configured to automatically modify relationships between the plurality of metrics and one or more objects of interest to the user, without requiring input from the user through the GUI. In some embodiments, the pipeline is configured to modify relationships between the plurality of metrics and one or more objects of interest to the user, based at least in part on input received from the user through the GUI. In some embodiments, the pipeline is configured to accept definitions of one or more metrology measurement methods.

### Dataflow for Pipelines

In some embodiments, the pipeline comprises a dataflow module configured to manage system input/output (IO) through the GUI, wherein the GUI comprises a plurality of options that enable the user to connect the user's system to the pipeline. In some embodiments, the plurality of options comprises a synchronization option, a source option, a destination option, and a transformer option.

In some embodiments, the synchronization option is configured to define triggering of a workflow in the pipeline. For example, the synchronization option can define how each flow is triggered. For example, the dataflow module may include a module (e.g., Watcher) to check the source status at regular intervals using a pooling method while another module (e.g., WebHook) opens an application programming interface (API) to notify the platform of changes in the source.

In some embodiments, the source option is configured to define an input source for the user's system and the pipeline. For example, the source option may define an input source for the platform with options like, e.g., DB, NAS, S3, and the platform described herein.

In some embodiments, the destination option is configured to define an output source for the user's system and the pipeline. For example, the destination option can define the output source for the platform with options like, e.g., DB, NAS, S3, and the platform described herein.

In some embodiments, the transformer option is configured to specify a modification to data received from the input source before saving modified data to a destination. For example, the transformer option can specify how data from the input source is transformed or modified before being saved to the destination. This operation could include changing file names or folder structures or adding new metafiles. In some embodiments, the modification comprises changing a file name, changing a folder structure, or adding a new metafile.

In some embodiments, the GUI permits the user to select a frequency of data synchronization from one of the following: stream, daily, manual, or passive. In some embodiments, the GUI is configured to enable the user to add one or more custom components to each of the plurality of options, and/or remove one or more components from each of the plurality of options.

### Throughput Performance of Pipelines and Real-Time Updates

In some embodiments, the plurality of metrology metrics comprise at least 100 metrology metrics. In some embodiments, the plurality of metrology metrics comprise at least 1000 metrology metrics. In some embodiments, the platform is configured to enable the user to obtain the plurality of metrology metrics from the process environment in a time duration of less than about 5 minutes.

In some embodiments, the platform is configured to enable the user to obtain the plurality of metrology metrics from the process environment in a time duration of less than about 1 minute. In some embodiments, the one or more visual display areas are configured to dynamically update the plurality of metrology metrics and the set of metrology images substantially in realtime, as the user is interacting with or customizing the pipeline using the plurality of graphical functions.

Objects, CDs and Image Types Associated with Pipelines

In some embodiments, the GUI is configured to permit the user to define one or more objects of interest from the set of metrology images. In some embodiments, key metrics can be defined with minimal user interaction. For example, the augmented metrology tool may allow automatically analyzing objects, automatically finding and copying the same definitions for similar objects, instantly modifying the result by tuning measurement methods according to user requirements, receiving direct user input to define objects when an automatic definition is impossible, automatically deriving metrics for defined objects, and modifying various relationships based on user input. In some embodiments, the one or more objects of interest comprise a deposited or fabricated structure that is formed in the process environment. In some embodiments, the plurality of metrology metrics comprise a plurality of critical dimensions (CDs) of the one or more objects of interest. In some embodiments, the set of metrology images is collected from the process environment. In some embodiments, the set of metrology images comprises scanning electron microscopy (SEM) images, transmission electron microscopy (TEM) images, and/or reflection electron microscopy (REM) images. While these processes may seem similar to conventional definition methods, the augmented metrology tool implements those technologies reliably and ensures stable measurements even for objects that are difficult to automatically measure.

Analysis Modules Associated with Pipelines

In some embodiments, the metrology platform further comprises an analysis module configured to analyze a distribution or correlation with yield among the plurality of metrics. For example, distributions could include continuous distributions (e.g., normal, standard normal, t, chi-square, or exponential) or discreet distributions (e.g., Bernoulli, binomial, uniform, or Poisson). In some embodiments, improvements to analysis methods are disclosed. In some embodiments, the distribution or correlation is analyzed within the set of metrology images and datasets for a single domain within the process environment. In some cases, domains can include metrology images and datasets generated from SEM images, TEM images, and/or REM images. For example, the augmented metrology tool provides recommendations for metrics by analyzing the distribution or correlation with yield among hundreds of metrics, both within and between images and datasets.

In some embodiments, the distribution or correlation is analyzed between or across multiple sets of metrology images and datasets for multiple domains within the process environment. In some embodiments, the analysis module is configured to recommend a set of metrics from the plurality of metrics to the user, based at least in part on an analysis of the distribution or correlation with yield among the plurality of metrics. For example, the augmented metrology tool provides recommendations on improvements for metrics by suggesting metrics with correlation to yield using the aforementioned method. In some embodiments, the GUI is configured to display the recommended set of metrics.

In some embodiments, the analysis module is configured to provide an analysis of a correlation between yield and various levels, from individual objects in metrology images to a process within the process environment. In some embodiments, the analysis comprises generating a score indicative of the correlation. In some cases, the score can range from 0 to 1. In some cases, the score is at least about 0.6, 0.7, 0.8, 0.9, or great. In some embodiments, the analysis further comprises generating a score interval at one or more confidence levels. In some cases, the confidence level ranges from 0 to 100%. In some cases, the confidence level is at least about 60%, 70%, 80%, 90%, or greater.

In some embodiments, the metrology platform further comprises an anomaly analysis module configured to provide anomaly information likely to impact metrology measurements. For example, data associated with manufacturing processes can differ significantly (e.g., anomalies) from other data due to continuously changing distribution of data. Data can include time series data with non-stationary characteristics. Non-stationary characteristics can comprise data drifts, data shifts, hierarchical data structures, or deviations in processes or equipment. Data drifts can cause steady or slow decreases in the accuracy of metrology measurements. Data drifts can occur due to aging in equipment or sensors. Data shifts can cause abrupt failures of metrology measurements.

Data shifts can occur due to, for example, changes in equipment or sensor characteristics after maintenance or calibration. In some embodiments, the anomaly information comprises object anomalies that indicate a presence and/or transformed state of one or more objects in one or more metrology images. In some embodiments, the anomaly information comprises one or more types of object anomalies. In some embodiments, the anomaly information is provided in a report displayed on the GUI. In some embodiments, the report is useable for analyzing process stability or issues.

GUI and pipeline modifications

In some embodiments, the augmented metrology tool includes methods of automation and customization for metrology and analysis and ways to effectively provide these through a user interface (UI) or graphical user interface (GUI). In some embodiments, the GUI is configured to allow the user to add one or more stages to the pipeline. In some embodiments, the GUI is configured to allow the user to remove one or more stages from the pipeline. In some embodiments, the GUI is configured to allow the user to remove modify one or more hyperparameters in the pipeline. In some embodiments, the GUI is configured to allow the user to customize one or more stages in the pipeline. In some embodiments, the GUI is configured to allow the user to modify one or more elements associated with object measurement and analysis. For example, the augmented metrology tool provides the ability to define measurement methods as a pipeline, add or remove stages in the pipeline, modify hyperparameters, customize new stages in the pipeline through pipeline extensions, modify specific elements of object measurement and analysis to be used in pipeline extensions through function extensions, and customize function extensions. A pipeline can be customized by the user to add, remove, or modify how the user wishes to take measurements of the objects or images. The ability to define and deploy pipelines that are designed for the user needs can promote efficiency and accuracy, resulting in greater quality and yield.

Extensions can allow for effortless personalization of each component. For functionalities not initially supported, user extensions are available, enabling users to build and apply their unique knowledge when needed. Users can build their own pipelines and modify the hyperparameters of each pipeline step. Additionally, the user can download public pipeline extensions from other users or the public domain.

The augmented metrology tool also provides the ability to extend the use of functions. For example, the users have the ability to select the primitives, samples, and/or reducers of their preference, or directly implement or build them. The users also have the option to download publicly available function extensions. These function extensions can be used when building the metric to be measured or actual metrology operations. A primitive may include a method of interpreting an object. For example, a primitive may include an ellipse or a line. When a user selects a primitive, it provides information that can be utilized in multiple metrics. For an ellipse, this information could be its minimum diameter, maximum diameter, or area. A sampler may play a pivotal role when multiple instances exist within an image because the sample may allow users to select a set of instances from which metrics will be extracted. A family of intra-samplers is useful in identifying interesting instances among those that belong to the same object. On the other hand, a family of inter-samplers can be used to analyze the relationships between different objects. A reducer may summarize the data obtained from the instances selected by the sampler. Given a set of instances and the information extracted by a primitive, a reducer may compile this data into a single metric. Some examples of reducers include a max reducer, which identifies the maximum value among instances' information retrieved by a primitive, or a mean reducer, which calculates the average.

For example, an intra-sampler can be used to select certain instances of objects. For these instances, an ellipse primitive may extract the minimum diameters of the instances. A mean reducer could then be employed to calculate the average of these minimum diameters, providing the final metric.

The augmented metrology tool provides a holistic approach to the challenges of measuring and analyzing objects in images, particularly in the semiconductor industry. By using these methods, users can enhance the speed and accuracy of their measurement and analysis processes, thereby improving yield and overall efficiency.

Simple measurement functionalities, such as defining a measurement point and replicating it, have already existed in industrial metrology tools. The augmented metrology tool introduces a new paradigm that transcends the concept of simple metrology. Instead, the augmented metrology tool can define an object either automatically or manually from the perspective of metrics, can provide extensive customization options, and can automatically or manually define relationships between objects based on metrics. The entire pipeline can also be organically constructed.

In addition, the augmented metrology tool mitigates a major limitation of other approaches, which only provide limited support for easily recognizable objects. By strongly supporting customization, the augmented metrology tool can expand into a comprehensive platform that allows users to hone their knowledge and offers a broader range of possibilities. Customization can empower users to go beyond simple measurements and engage in a more comprehensive, user-driven analysis.

The augmented metrology tool can be commercially utilized across various stages of semiconductor metrology, from product research to mass production, yield analysis, and any team/field that utilizes image-based metrology. As it can significantly enhance the qualitative, quantitative, and speed aspects of existing metrology, it can greatly expedite the most crucial improvement cycles in semiconductor development.

The augmented metrology tool provides advanced visual information extraction. For example, the augmented metrology tool can seamlessly extract extensive metrics from all types of semiconductor images with minimal human interaction, underscoring the tool's proficiency and versatility. Also, the augmented metrology tool can assist in generating in-depth image data analysis. For example, the augmented metrology tool can employ a vast array of metrics for comprehensive and sophisticated analysis, such as pinpointing crucial parameters including yield analysis. Further, the augmented metrology tool can allow customizable extensions that are unique, tailor-made for semiconductor exploration, which may simplify the extraction and appraisal of innovative metrics and features.

Regardless of role or team, the augmented metrology tool can be a critical key tool for unifying all engineers involved in semiconductor metrology, inspection, and yield. This common platform can enable engineers to execute tasks on individual wafers while managers can gain immediate visibility into operations. Compared to traditional team structures that may rely on fragmented software and technologies for the same tasks, the augmented metrology tool can improve the workflow. By leveraging its robust measurement skills and comprehensive analytics, the augmented metrology tool can fuse these divergent components into a single, streamlined stack, improving efficiency and coherence.

With its fast learning curve and streamlined setup, the augmented metrology tool can be swiftly adopted and utilized to deliver immediate results. Setting up the entire pipeline can require few resources, which may improve speed and convenience. The augmented metrology tool can utilize some or all types of semiconductor images. Thus, by using a standard measurement algorithm, the augmented metrology tool can generate consistent trend outcomes across all teams and data domains to improve fostering of a unified understanding and approach.

The augmented metrology tool can also enable the users to perform evaluation and analysis of un-predefined or predefined objects. The augmented metrology tool may be used to identify objects of interest. The tool can assist users, acknowledging that each user may have unique points of interest or perceive different characteristics in the same object and that some objects can be ambiguous. When the user wants to measure predefined objects (e.g., a library of existing objects or predefined by the user in a previous evaluation session), the augmented metrology tool may also function to consistently and accurately identify objects predefined by the user in new images at greater speeds and greater accuracy.

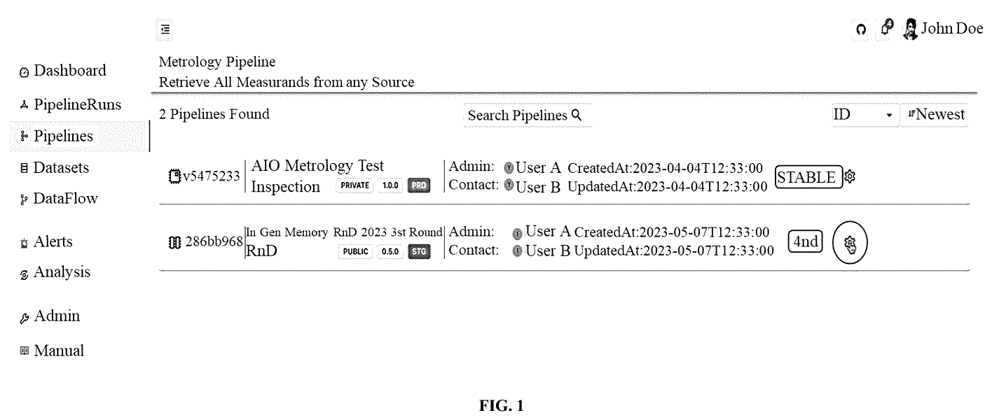

FIG. 1 shows an example screenshot of the user interface of the augmented metrology tool, in accordance with some embodiments. A Dashboard page may be used to display a plurality of information that is relevant and of interest to the user. The user may also navigate to a plurality of other pages, such as PipelinesRuns pages, Pipelines pages, Datasets pages, DataFlow pages, Alerts pages, Analysis pages, Admin pages, and Manual pages. In some cases, pages can include one page or more than one page. FIG. 1 shows the Pipeline page where the user is able to select a metrology pipeline to configure, but embodiments are not limited thereto. Furthermore, although not shown, a deployment button (or deployment tool) may be included near or next to the edit button where the gear is shown for each pipeline.

The PipelinesRuns page provides a comprehensive result that includes logs from the operation of deployed pipelines, which can enhance transparency and traceability. The Pipelines page allows users to define and deploy pipelines that are specifically designed for their measurement needs, which promotes efficiency and accuracy. The Datasets page provides access to the datasets that are captured from images, which may already be processed or still pending, along with various meta information about the dataset. The DataFlow page may provide support for automatically pulling datasets, which can improve usability and reduce the time spent on data preparation. The Alerts page may allow users to set custom alerts when the measured values or system status exceeds certain thresholds, which can ensure prompt awareness and response to potential issues. The Analysis page can offer in-depth analysis of measured values, enabling users to gain holistic insight from their data.

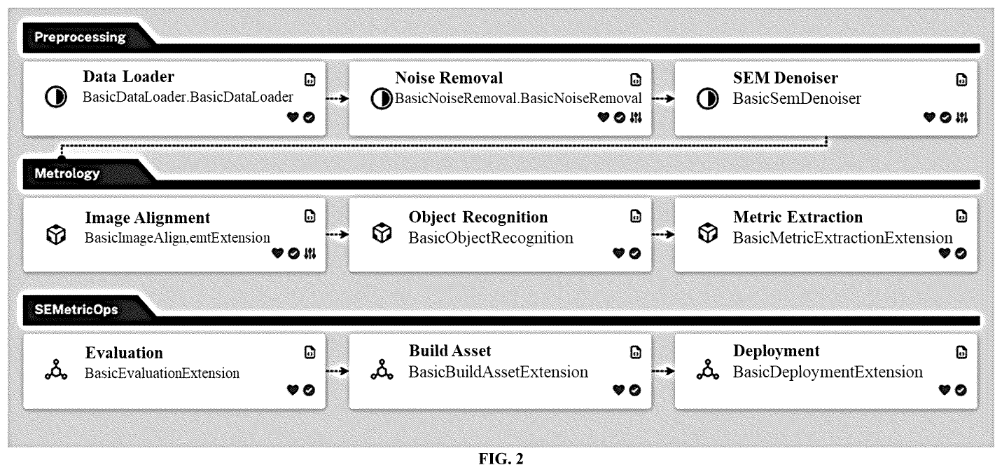

FIG. 2 shows an example screenshot of the user interface of the pipeline configuration page, in accordance with some embodiments. Once a pipeline is selected from the pipeline selection page, the individual components or processes within the pipeline can be configured.

The pipeline configuration page may include several tools. The Pipeline tool may enable a user to review and adjust the metrology pipeline, allowing the user to add or remove components as well as tweak the parameters of each component. The Object tool lets the user examine the structure of the dataset and accordingly define objects for each image group. The augmented metrology tool empowers the user to define even ambiguously structured objects quickly, accurately, and effortlessly by adjusting multiple parameters or utilizing the tools provided. The Metric tool, much like the Object tool, allows the user to examine the structure of the dataset. The Metric tool facilitates the definition of numerous metrics for each image group, in line with the objects pre-defined in the Object tool, manually or automatically. Users have the freedom to define each metric individually or effortlessly create them via a MetricBuilder. For the Evaluation tool, the user can directly evaluate the generated metrology pipeline against the dataset. It provides an overall analysis of the actual pipeline and offers summaries and charts on the trends and stability of metrics. If further tuning is required, users can repeat the processes using the Pipeline, Object, Metric, and Evaluation tools to improve their results in their desired direction. Unlike the previous pages, the Build tool converts the built metrology pipeline into an asset for official registration. This transformation allows for the metrology pipeline to be stored, managed, and utilized for deployment. Lastly, the Configuration tool a page that displays multiple configurations for edit mode.

The pipeline may include preprocessing steps which may include a data loader tool, noise removal tool, and scanning electron microscopy (SEM) denoiser tool. For example, the user may configure what kind of data may be used or loaded with the data loader tool. The noise removal tool may remove noise from the images that were collected using the data loader. The SEM denoiser may assist with removing additional noise from the SEM images that are provided by the noise removal tool.

Once the preprocessing is complete, various metrics may be provided by the metrology steps with an image alignment tool, object recognition tool, and metric extraction tool. For example, the image alignment tool may be used to align the image in a certain orientation or zoom so that the area of interest may be evaluated. Then the object recognition tool may be used to identify objects of interest within the image. Then the metric extraction tool may be used to extract various metrics from the image such as length, width, depth, color, pattern, etc.

Furthermore, the pipeline may include additional analysis tools such as evaluation tool, build asset tool, and deployment tool. The evaluation tool provides an overall assessment of the actual pipeline, offering summaries and charts on the trends and stability of metrics derived from a direct evaluation of the generated pipeline against the dataset. If further tuning is required, the tool facilitates the repetition of processes for result improvement. The build asset tool transforms the built pipeline into an asset ready for official registration. This transformation facilitates the storage, management, and utilization of the pipeline for deployment.

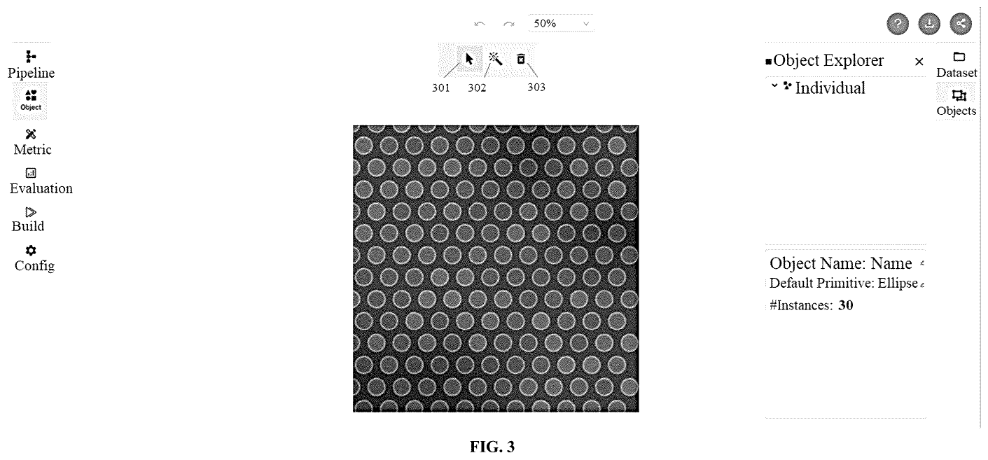

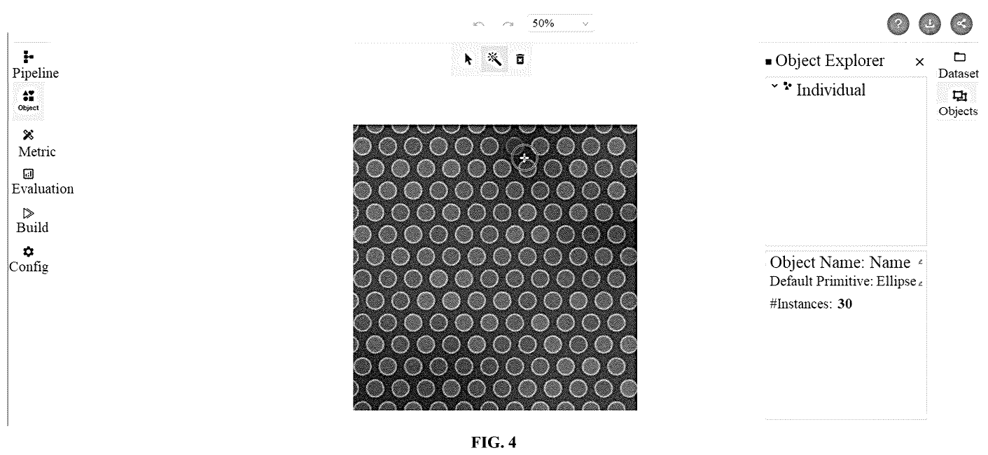

FIG. 3 shows an example screenshot of the user interface of an object configuration tool, in accordance with some embodiments. The object configuration tool may be used to detect various objects from a captured image. A captured image may be presented as shown in FIG. 3. The object configuration tool may include a selection tool 301, a wand tool 302, and a deletion tool 303 that can be used to create an outline or structure of the object for detecting the objects. The selection tool 301 may be used to select the outline of the object. The wand tool 302 may be used to create the outline of the object (see FIG. 4). The deletion tool 303 may be used to delete the outline.

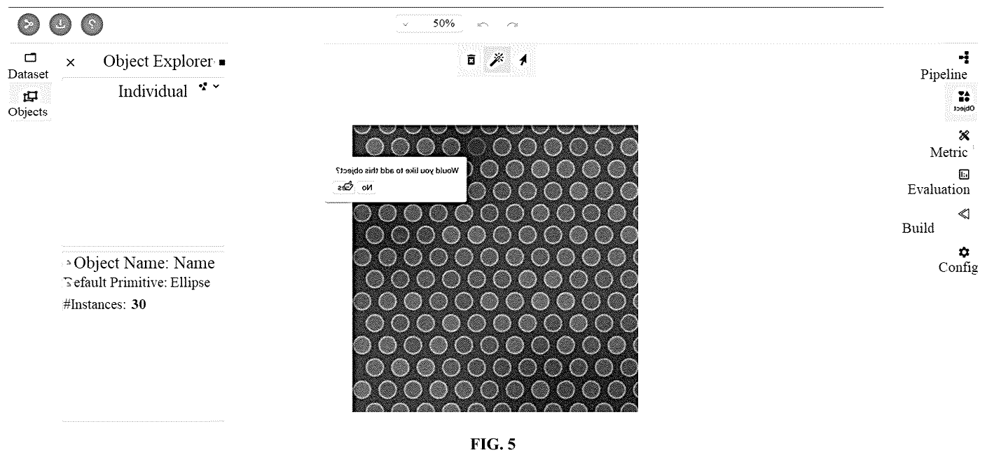

FIG. 4 shows another example screenshot of the user interface of the object configuration tool, in accordance with some embodiments. To create an outline, the wand tool 302 may be used. With the cursor, the user may select a portion of the image by clicking any point in the image and dragging the cursor to create an area that the user wishes the object configuration tool to automatically detect. The area may include the object that the user wishes to detect. Once the area is selected and the cursor is released, the user may be prompted on whether the user wishes to add the object to be detected, as shown in FIG. 5. When selecting yes, the user may be shown an object analytic tool.

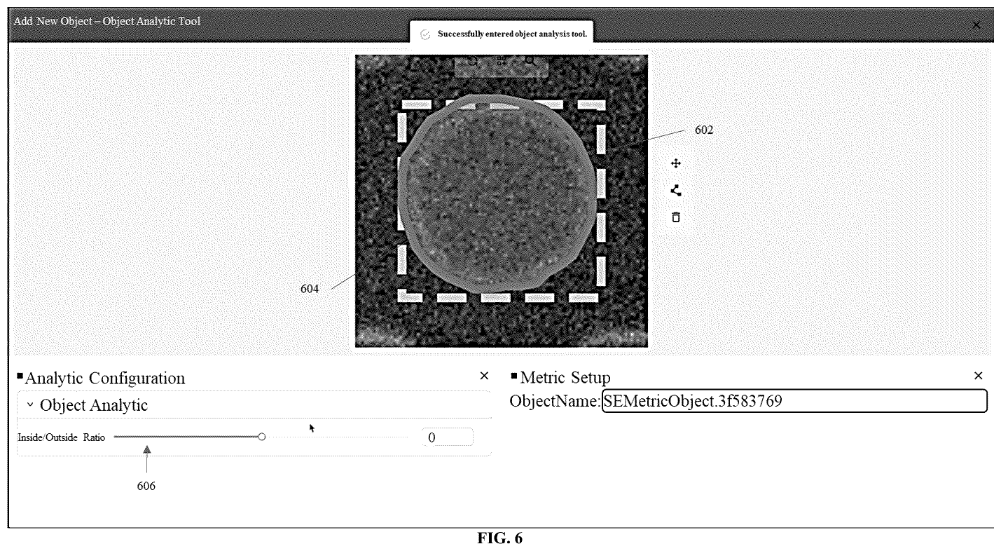

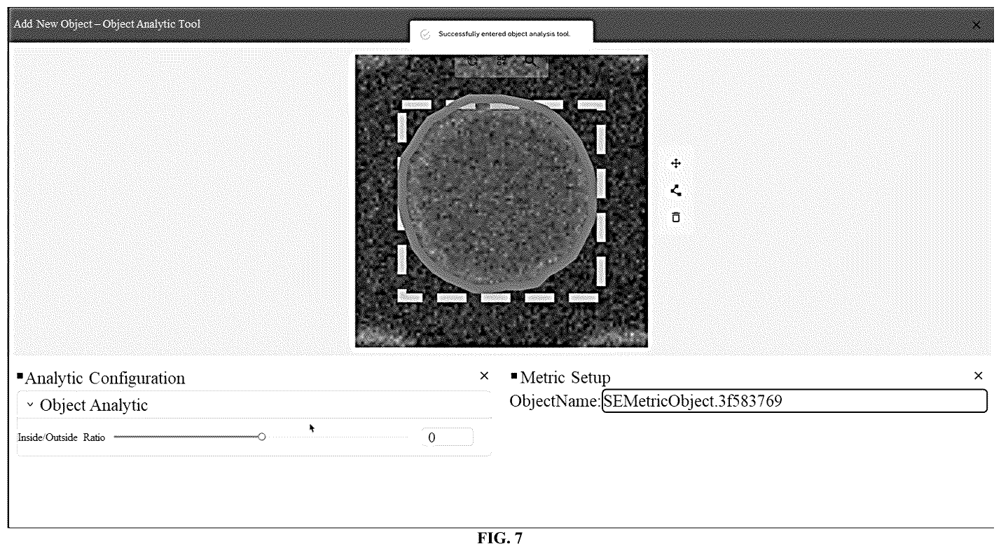

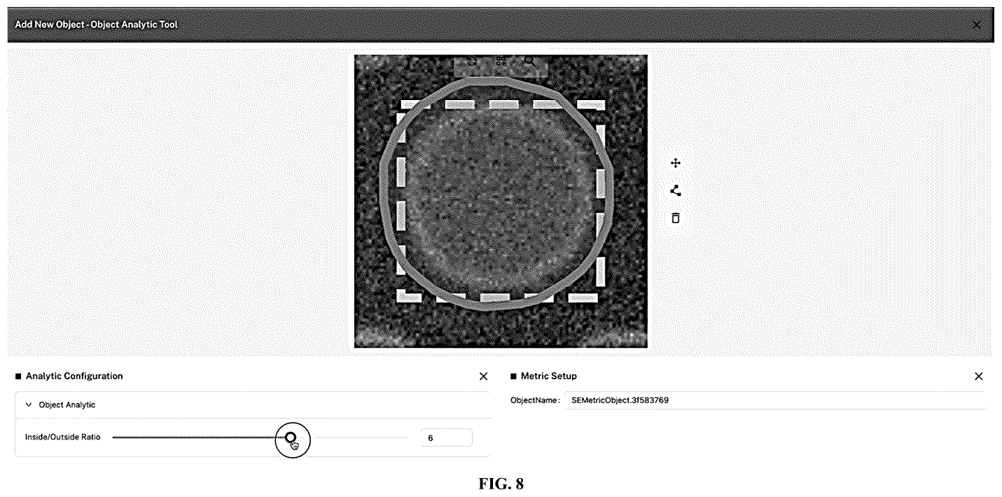

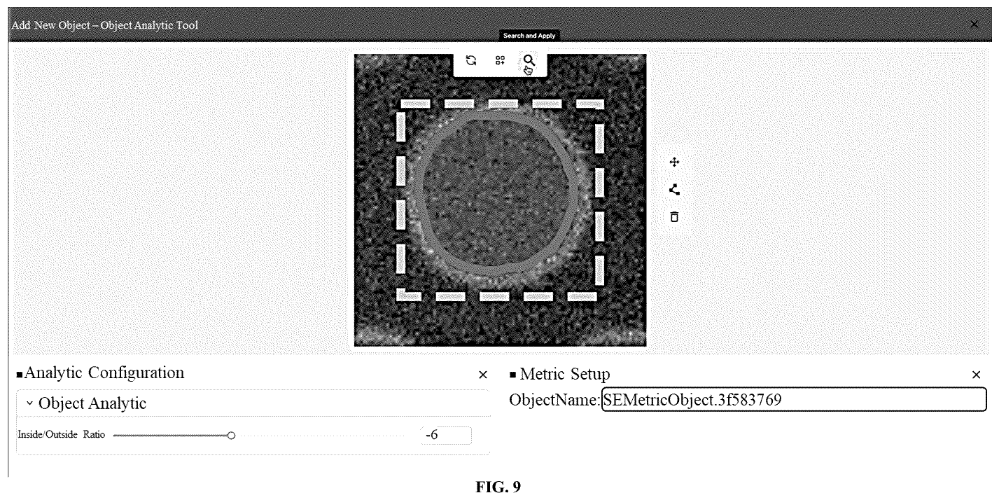

FIG. 6 shows an example screenshot of the user interface of the object analytic tool, in accordance with some embodiments. Once an area is selected, the user may wish to fine-tune the outline of the object to be detected. The object analytic tool can be used to create the outline. The size and location of the outline can be adjusted to closely align the object that the user is trying to detect and measure. The area selected by the user may be shown as area 602, and the outline 604 may be created by adjusting the size of the outline. The adjustment may be made by the ratio adjuster tool 606 which can adjust the ratio between the inside and outside of the outline. If the ratio is decreased, the outline may be made smaller, as shown in FIG. 7, and if the ratio is increased, the outline may be made larger, as shown in FIG. 8. Once the size of the outline is adjusted to a desired amount, the user may the select the “search and apply” icon to allow the object configuration tool to find additional objects that are similar to the outline, as shown in FIG. 9.

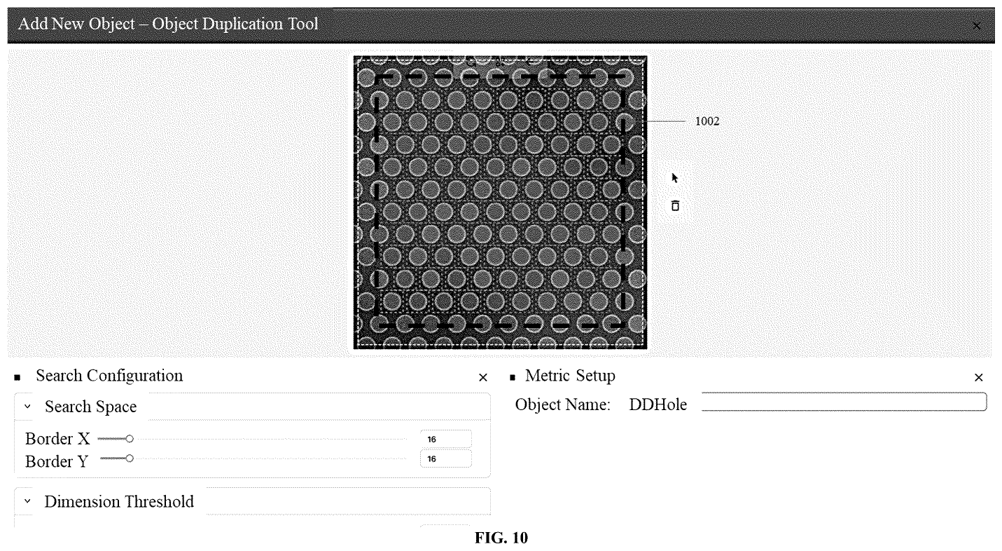

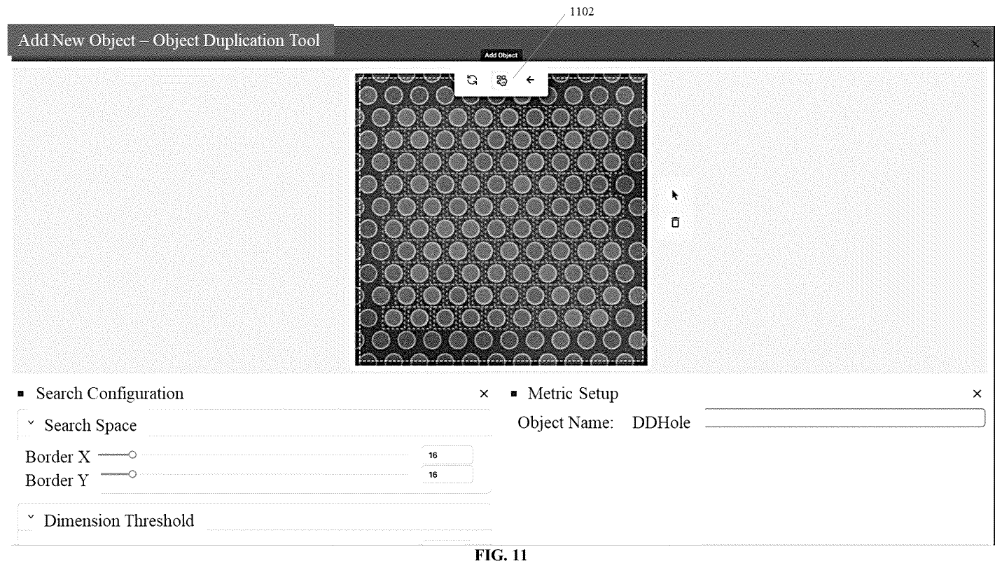

FIG. 10 shows an example screenshot of the user interface of an object duplication tool, in accordance with some embodiments. The object duplication tool may be used to duplicate and detect additional objects, as shown in the selected portion 1002. For example, once the outline of the object is selected using the object analytic tool, the object duplication tool can use the outline to find similar objects that fit in the outline within a selected portion of the image. The size of the selected portion where the object duplication tool searches for other similar objects can be adjusted by changing the search space size in the x and y directions. And once the object is detected, the object can be labeled in the metric setup section. Once the desired objects have been automatically detected within the selected portion 1002, the user may select the add object button 1102 as shown in FIG. 11 to add the detected objects to the original image.

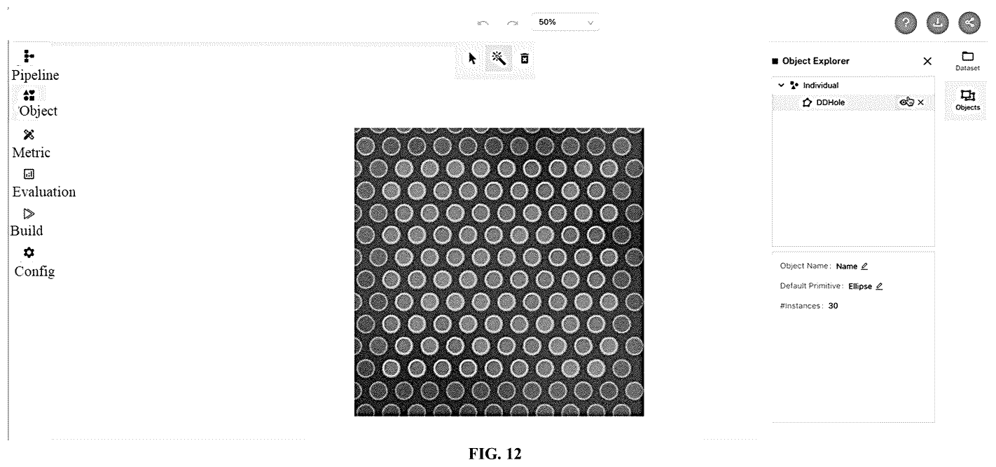

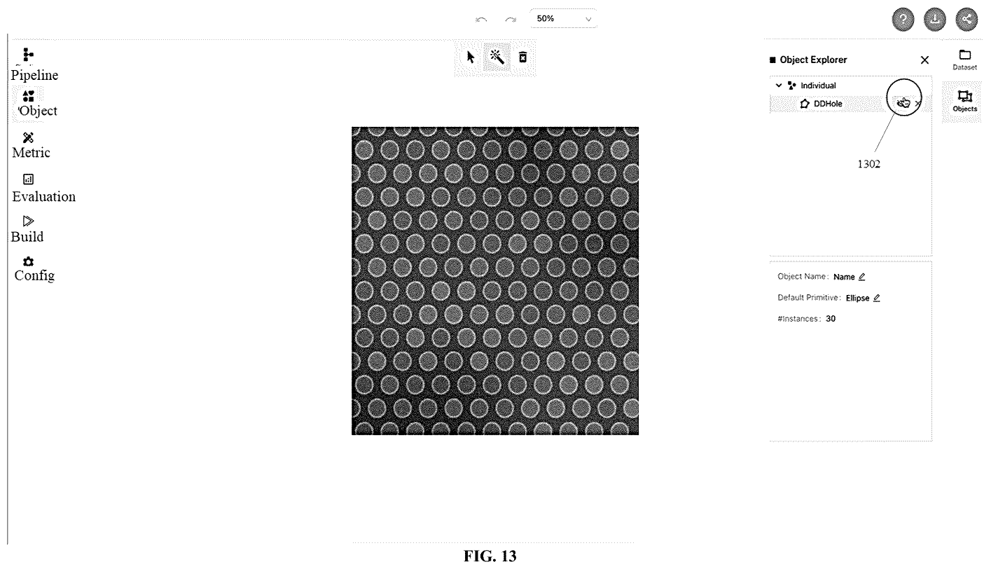

FIG. 12 shows an example screenshot of the user interface of the object configuration page, in accordance with some embodiments. Once the objects are detected, the detected objects may be highlighted in a different manner than when the objects before confirmation as shown in FIG. 11. For example, the added objects may have a different color than the previously undetected objects. Further, the object configuration page may include an object explorer widget that can be used to navigate the detected objects (or outlines of objects). Each of the added objects (as defined by the outlines) may be assigned a unique identification number that can identify which object is being measured and evaluated. Within the object explorer widget, the detected objects may be made visible or invisible using an icon 1302 next to the name of the object, as shown in FIG. 13.

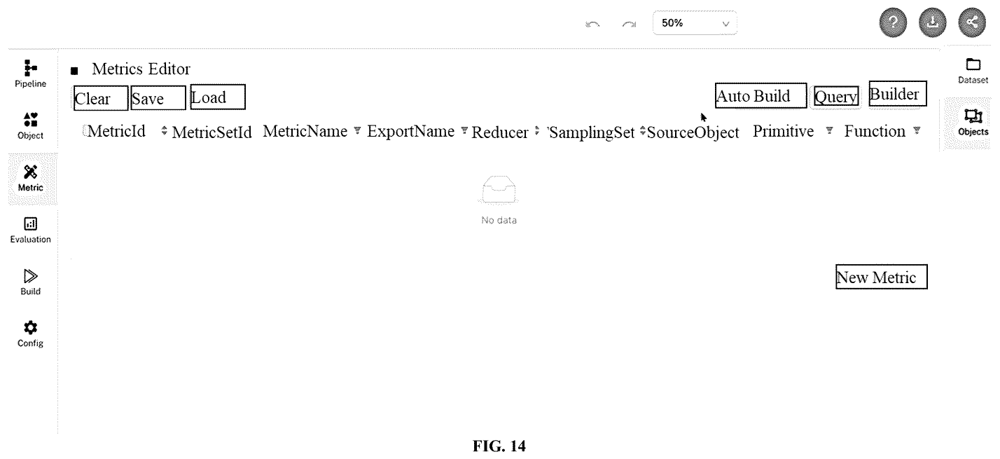

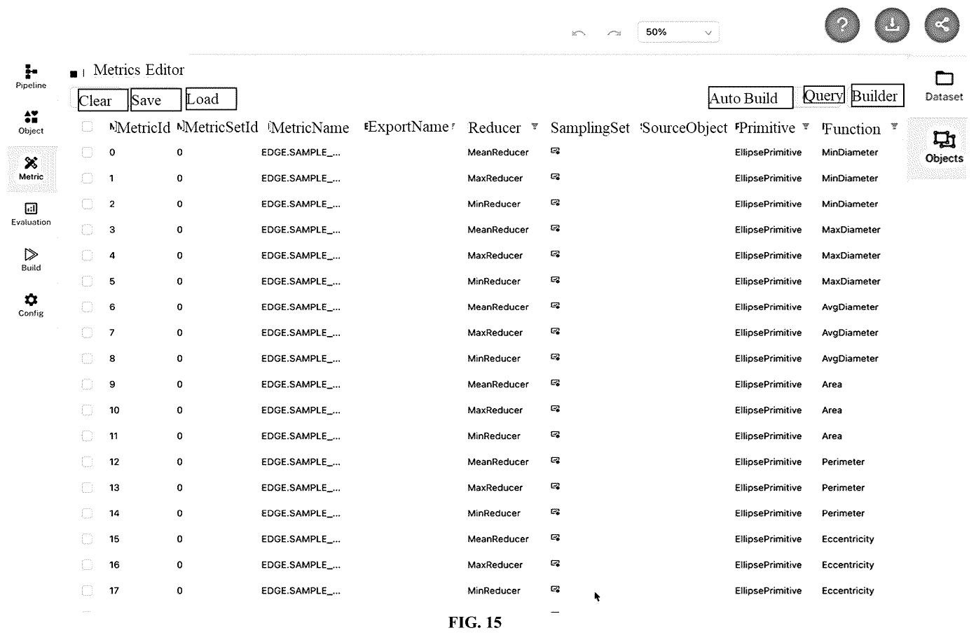

FIG. 14 shows an example screenshot of the user interface of the metrics editor page, in accordance with some embodiments. The metrics editor page can be used to list the added objects and the various measurands of the objects that are being measured. Once the Auto Build button is pressed, the list of added objects can be provided, as shown in FIG. 15.

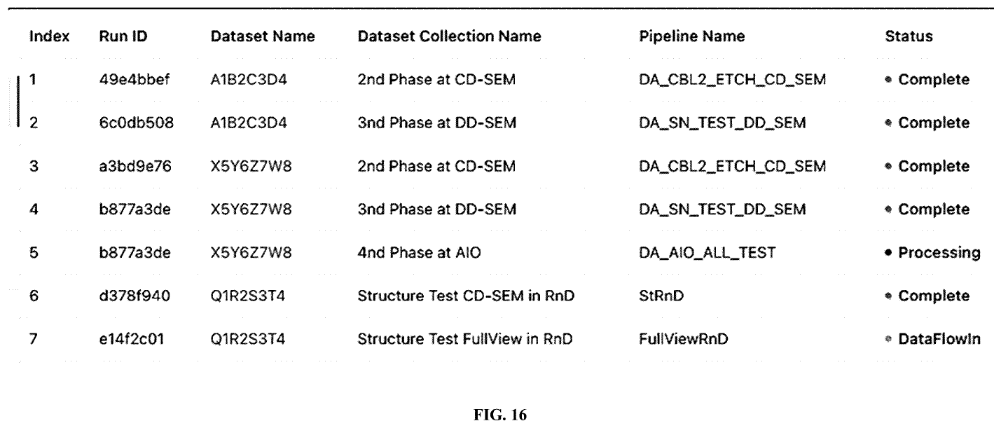

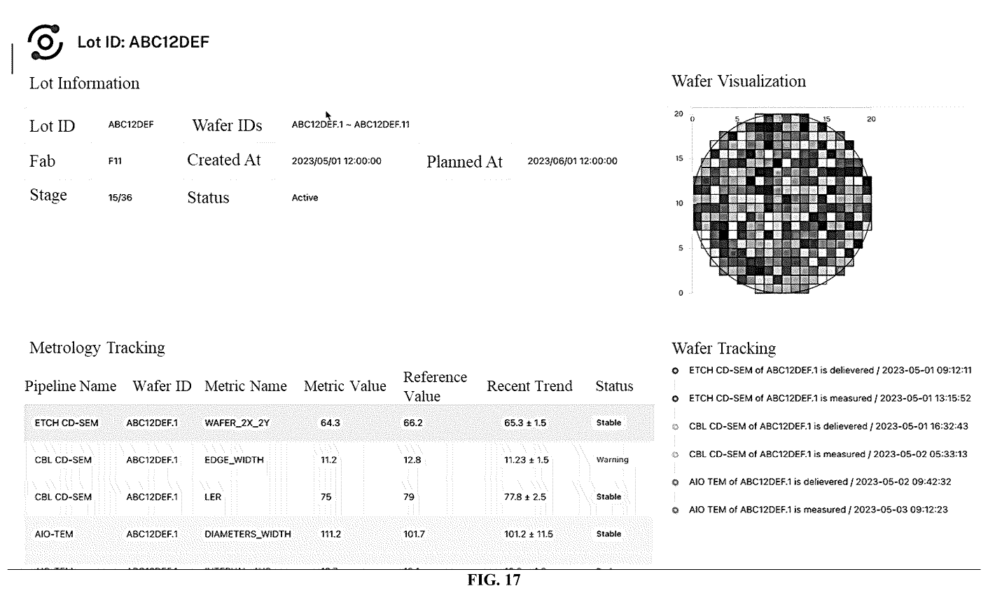

FIG. 16 shows an example screenshot of the user interface of the Pipelineruns page, in accordance with some embodiments. The Pipelineruns page may provide a comprehensive result that includes logs from the operations of the deployed pipelines. This provides enhanced transparency and traceability. Once a dataset is selected, additional evaluations may be performed using the information provided, as shown in FIG. 17. The information may include lot information, metrology tracking, wafer tracking, and a wafer visualization. The lot information may include details about the conditions in which the dataset was collected. The metrology tracking information may include different metrics that were collected from the dataset. The wafer visualization may show at a high-level the quality of a certain characteristic with color-coding or patterning or other means, giving the user a quick view of a particular metric across the wafer. A certain portion of the wafer visualization tool may be selected to get a more in-depth view of the metrics of that portion of the wafer. The wafer tracking may provide a log of the metrics different steps in evaluating metrics.

FIG. 17 shows an example screenshot of the user interface of the PipelineRuns page, in accordance with some embodiments. The PipelineRuns page may provide a comprehensive result that includes logs from the operations of the deployed pipelines. This provides enhanced transparency and traceability.

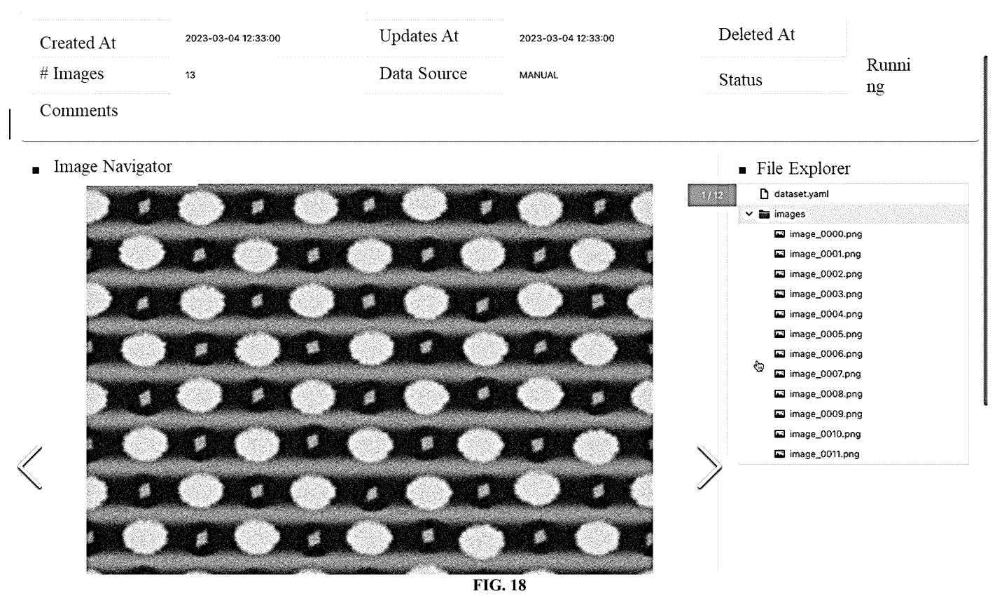

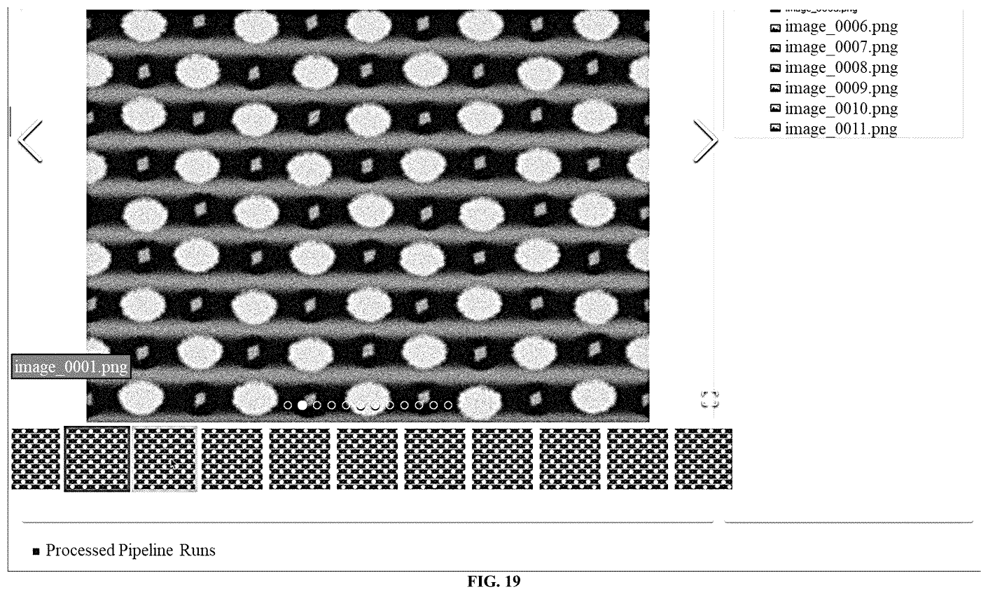

FIG. 18 shows an example screenshot of the user interface of the Datasets page, in accordance with some embodiments. The Datasets page can provide access to the user, whether the data is processed or pending, along with meta information about the dataset (e.g., creation date, updated date, number of images, data source, status, etc.). As shown in FIG. 19, the user can select various images that were captured.

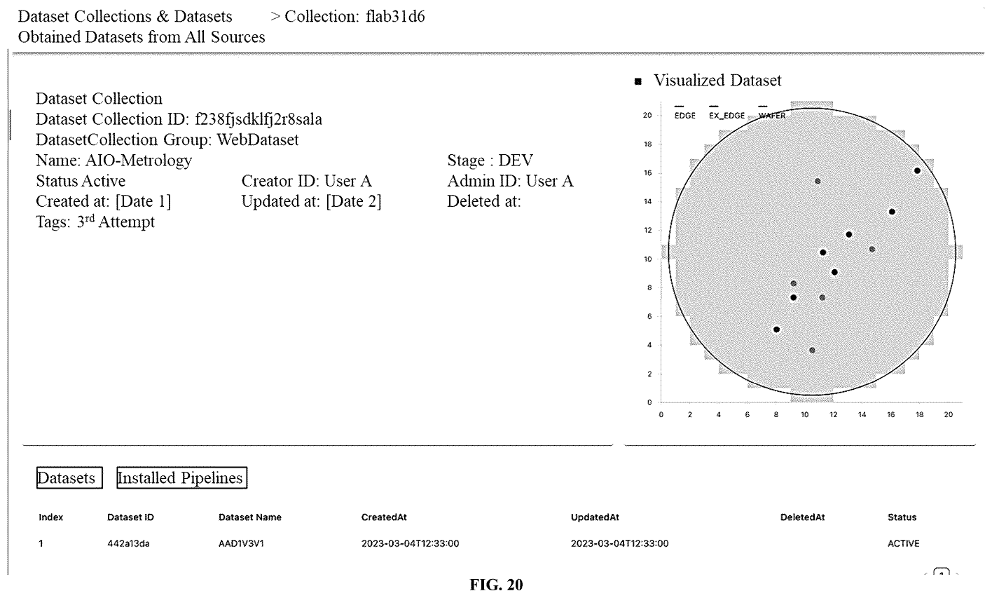

FIG. 20 shows another example screenshot of the user interface of the Datasets page, in accordance with some embodiments. Additional information may be provided using the Datasets page, such as a visualization of the dataset in the wafer.

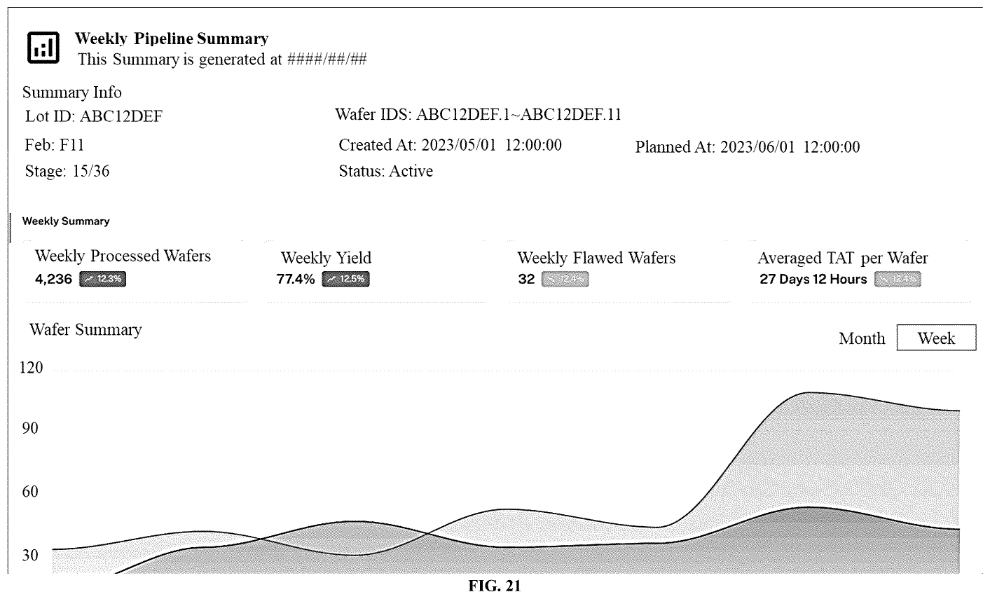

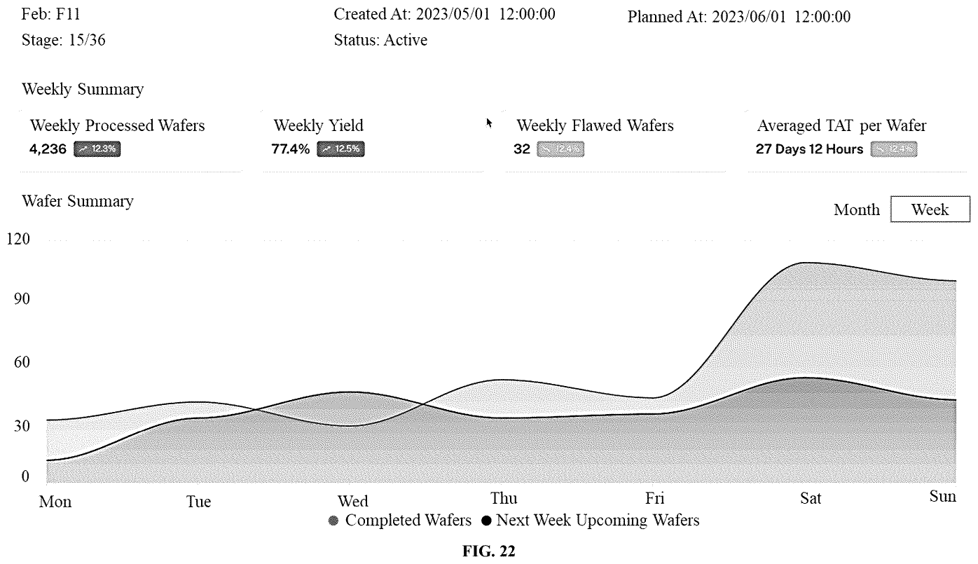

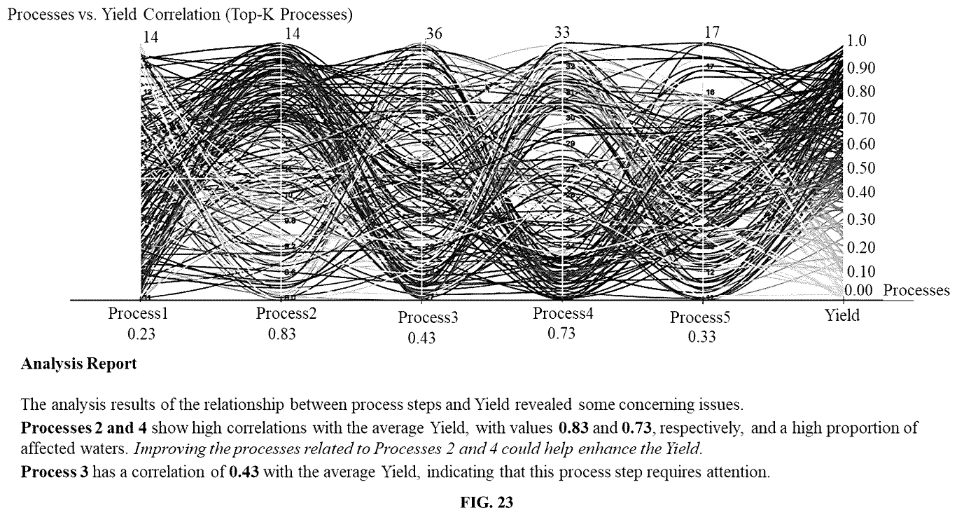

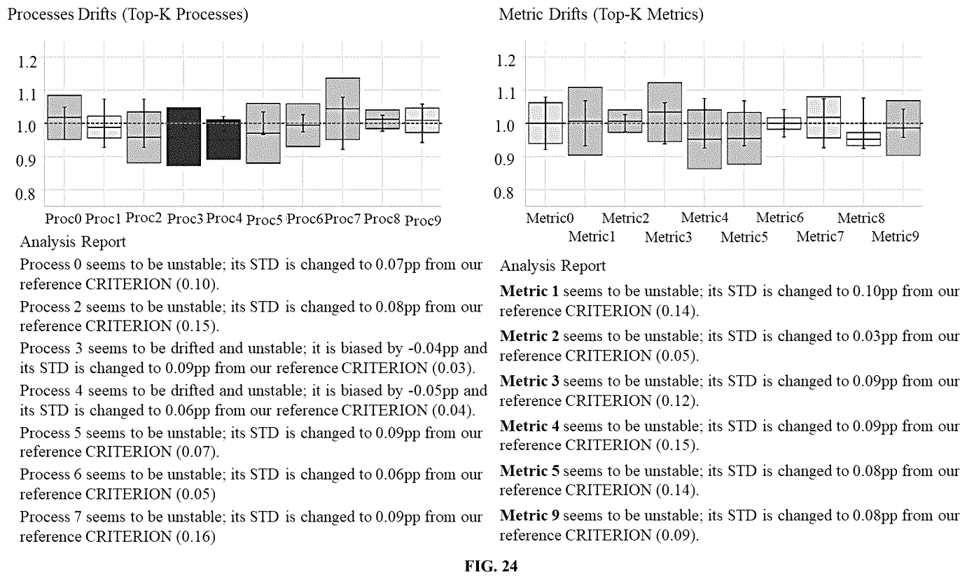

Each of FIGS. 21-24 shows an example screenshot of the user interface of the Analysis page, in accordance with some embodiments. FIG. 21 shows a high-level summary of the data that was collected and evaluated within the last week. For example, the data may show the weekly processed wafers, weekly yield, weekly flawed wafers, and average turnaround time (TAT) per wafer. Also, although the wafer summary is provided on a per-week basis, embodiments are not limited thereto and the period may be customized to be shorter (e.g., day, hour, etc.) or longer (e.g., biweekly, monthly, quarterly, yearly, etc.). FIG. 22 shows a graph of the number of wafers that have been evaluated and the number of wafers that are going to be evaluated. FIG. 23 shows a graph of the correlation between process and yield. For example, the graph may show multiple processes and their yield curves for a particular metric, wafer or dataset. Based on the data, the augmented metrology tool may also provide an analysis report that compares the various processes. FIG. 24 shows a series of box plots that show process drifts and metric drifts, along with analysis reports for the data that is shown. The box plots may be color-coded so that the user can easily compare the good process (or metric) to a bad process (or metric).

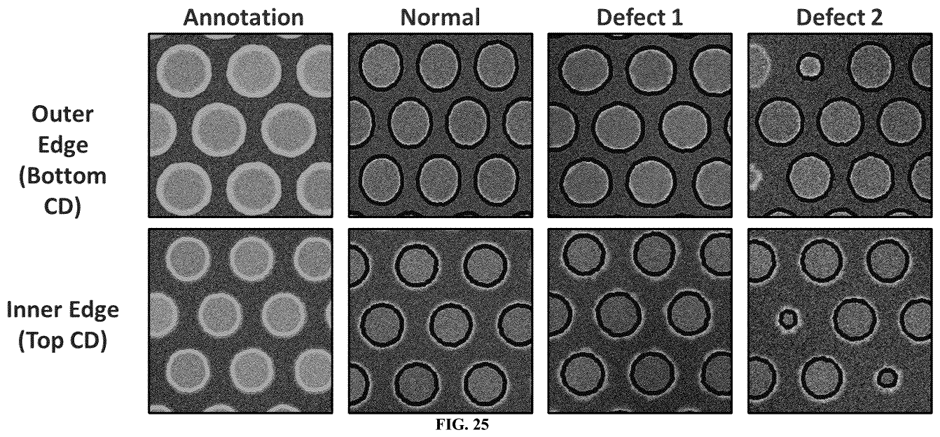

FIG. 25 shows a set of example images with objects that have been annotated by the user and detected by the augmented metrology tool, in accordance with some embodiments. When tool is measuring the objects, the tool can detect when the objects have a normal characteristic (as shown under the Normal column) or the objects have defects (as shown under the Defect 1 and Defect 2 columns). The tool may determine how close the detected objects are to the annotated objects (e.g., outline defined by the user) within a predefined or automatically set threshold. Then the tool can show the user where the objects are normal or where the objects have defects.

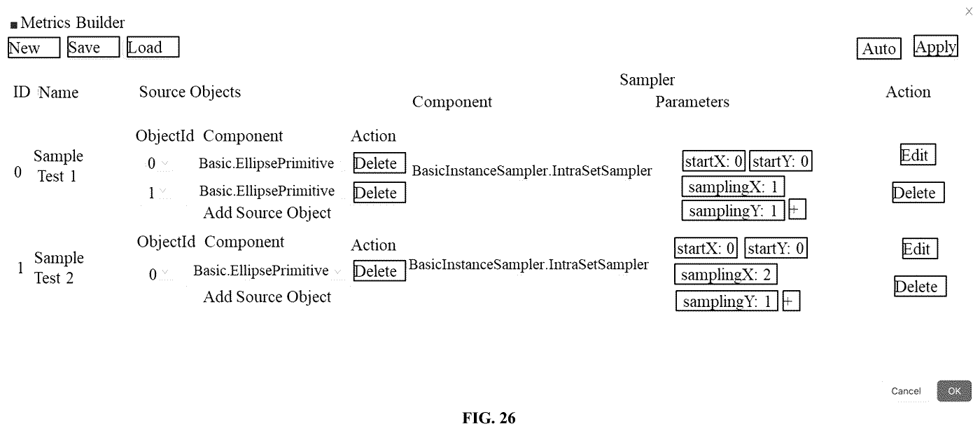

FIG. 26 shows an example screenshot of the user interface of the Metrics Builder tool, in accordance with some embodiments. The Metrics Builder tool may be accessed from the Metrics Editor tool (FIG. 14). The Metrics Builder tool is designed to effectively propose numerous metrics. Users can first utilize the automatically provided Builder Config and add a few build options if desired. For instance, without the Metrics Builder tool, users may have to input all the information such as which primitive to select, which information to use, and how to sample. However, the Metrics Builder facilitates this by setting these factors at a higher level, thus automatically creating metrics with minimal interaction. As shown in FIG. 26 as an example, in this setting, the Metrics Builder tool may generate about 50 metrics from the second row.

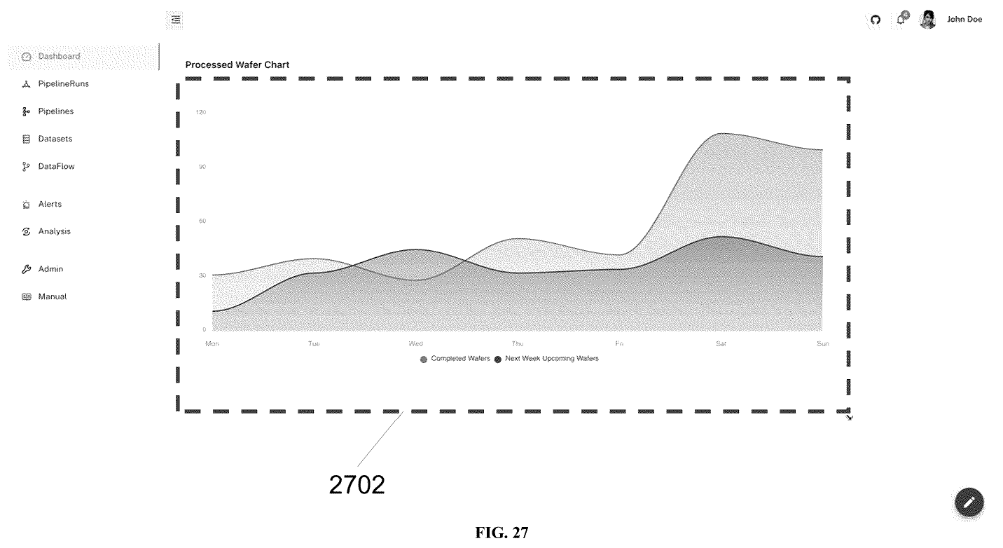

Each of FIGS. 27-29 shows an example screenshot of the user interface of the Dashboard page, in accordance with some embodiments. In some embodiments, the GUI comprises a dashboard comprising a plurality of panels that display information about the user's system and the pipeline. The Dashboard page may be interactive and allow users to freely arrange any analytical tools concerning all the information used in the augmented metrology tool. In some embodiments, the information comprises a resource status. In some embodiments, the information comprises pipeline workflow run successes or failures.

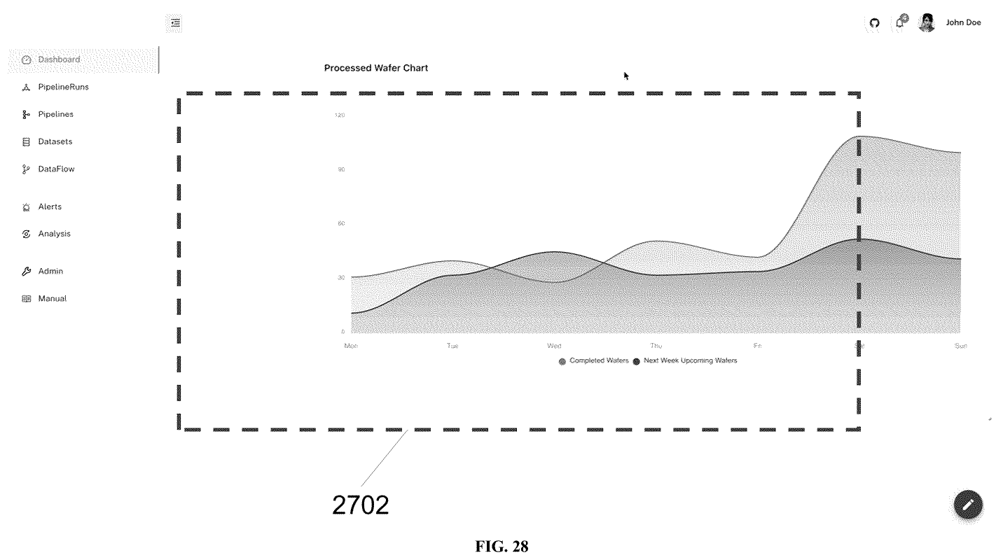

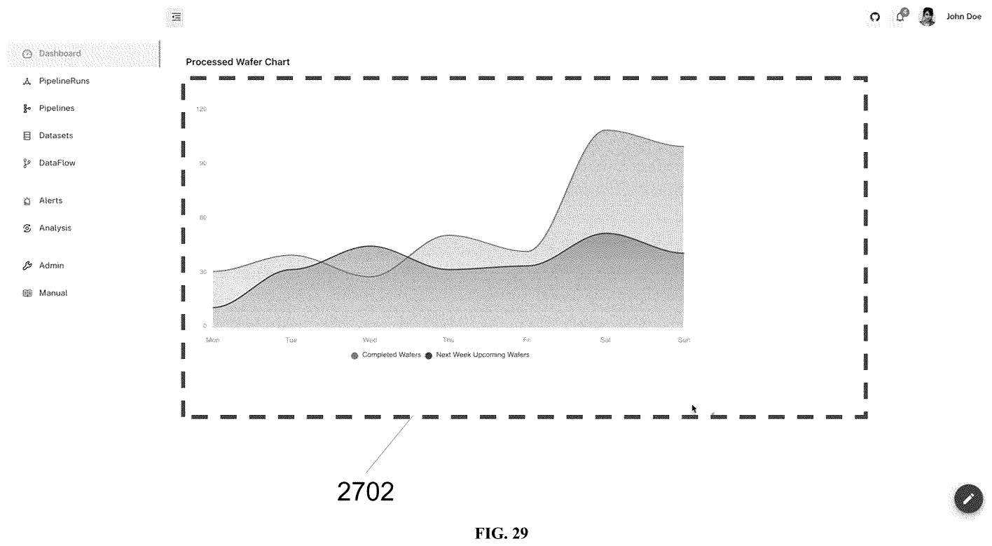

In some embodiments, the GUI is configured to enable the user to modify the dashboard by adding a new panel and/or removing an existing panel. For example, users can freely choose the size and location of one or more widgets to be displayed on the Dashboard page and can also freely select attributes such as the duration and properties to display for metrics and the amount of information handled by the system. This allows users to check the information of interest at a glance. For example, FIG. 27 shows a widget (e.g., showing a process wafer chart) within a box 2702. The user may move the widget to a different location within the Dashboard page such that the widget is outside the box 2702, as shown in FIG. 28. In some embodiments, the GUI is configured to enable the user to adjust a size and/or position of one or more panels on the dashboard. For example, the user may also shrink the widget by dragging a corner of the widget such that the widget is smaller than the box 2702, as shown in FIG. 29. Although not shown, the widget may be enlarged to be bigger than the box 2702 as well.

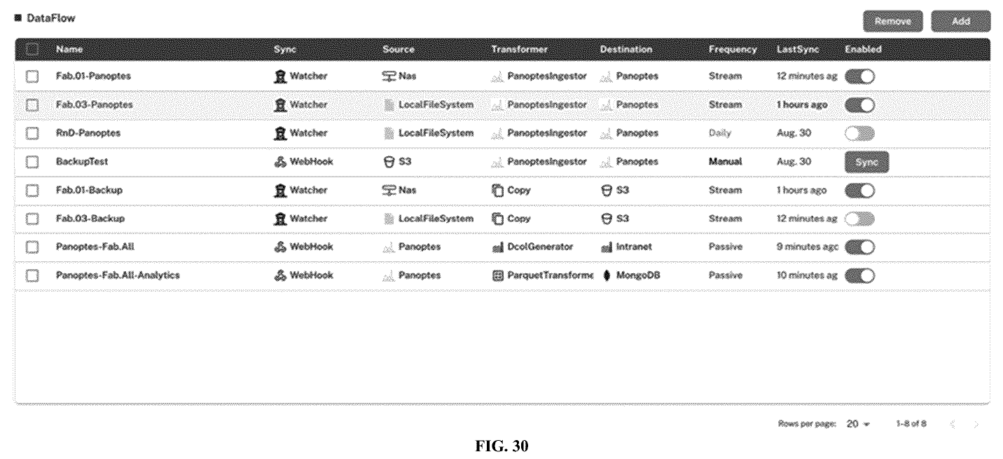

FIG. 30 shows an example of a screenshot of a dataflow user interface or page (e.g., DataFlow page), in accordance with some embodiments. The dataflow user interface can include a synchronization option, a source option, a destination option, and a transformer option. The synchronization option can be configured to define triggering of a workflow in the pipeline. For example, the synchronization option can define how each flow is triggered. For example, the dataflow module may include a module (e.g., Watcher) to check the source status at regular intervals using a pooling method while another module (e.g., WebHook) opens an API to notify the platform of changes in the source. The source option can be configured to define an input source for the user's system and the pipeline. For example, the source option may define an input source for the platform with options like, e.g., DB, NAS, S3, and the platform described herein. The destination option can be configured to define an output source for the user's system and the pipeline. For example, the destination option can define the output source for the platform with options like, e.g., DB, NAS, S3, and the platform described herein, the transformer option can be configured to specify a modification to data received from the input source before saving modified data to a destination. For example, the transformer option can specify how data from the input source is transformed or modified before being saved to the destination. This could include changing file names or folder structures or adding new metafiles. The modification can include changing a file name, changing a folder structure, or adding a new metafile. The GUI can permit the user to select a frequency of data synchronization from one of the following: stream, daily, manual, or passive. The GUI can be configured to enable the user to add one or more custom components to each of the plurality of options, and/or remove one or more components from each of the plurality of options.

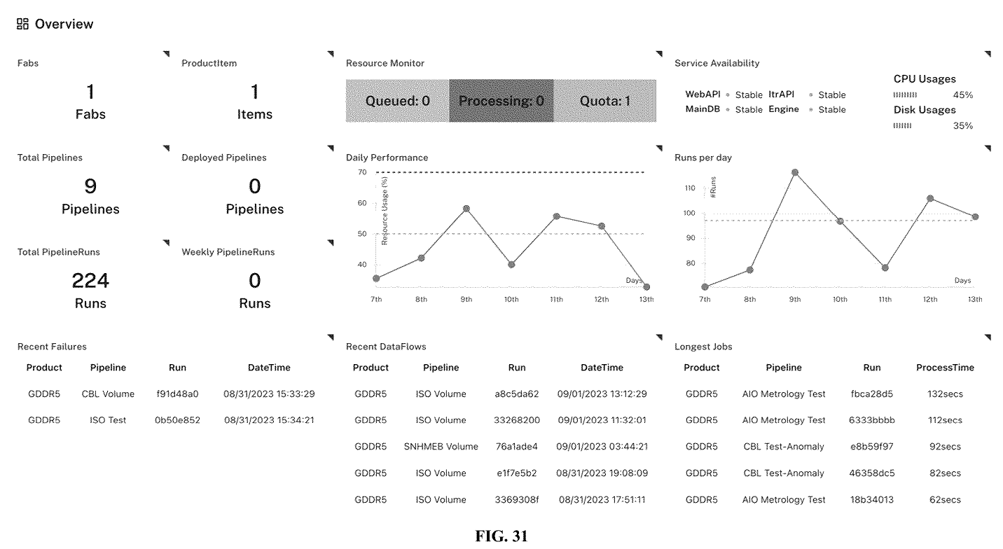

FIG. 31 shows an example of a screenshot of a platform or systems overview user interface or page, in accordance with some embodiments. In some cases, the overview page can be accessed from the user interface of the augmented metrology tool. The page can be configured to display various system information. Information can include, e.g., number of fabs, number of production items, total pipelines, deployed pipelines, total pipeline runs, weekly pipeline runs, recent failures (product, pipeline, run, data, time, and the like), resource monitor, daily performance, recent dataflows (product, pipeline, run, data, time, and the like), service availability, CPU usages, runs per day, or longest jobs (product, pipeline, run, data, time, and the like). Users can create or add new panels to monitor system information. Users can delete or remove panels. Users can reposition and resize panels.

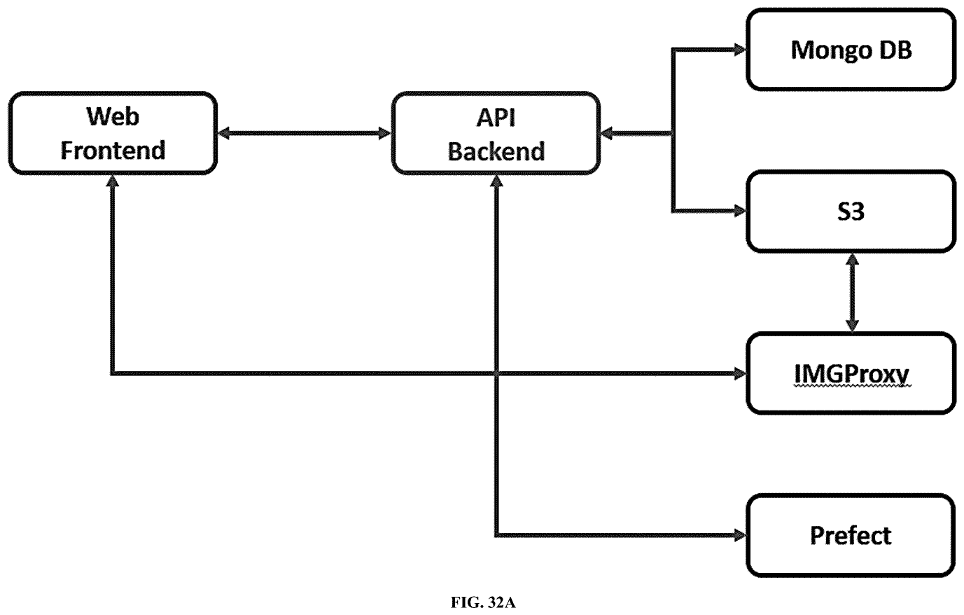

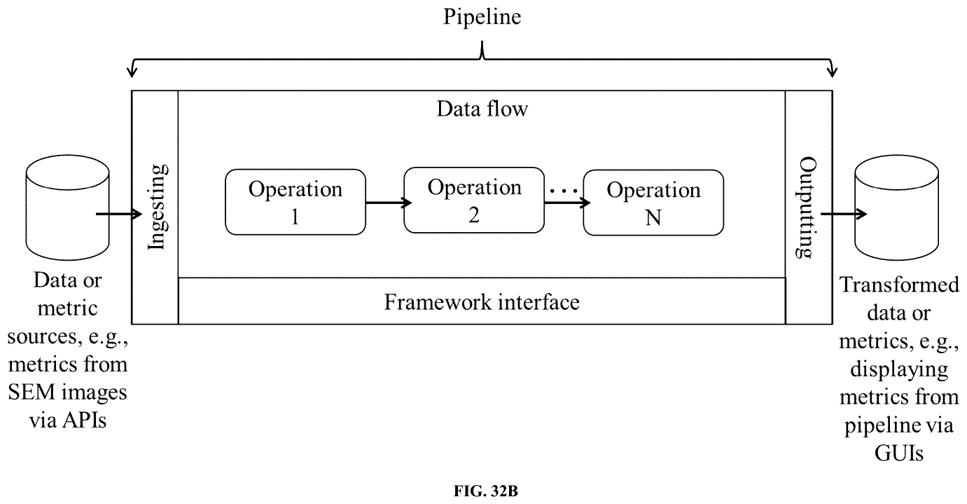

FIGS. 32A-32B show an example high-level system architecture diagram of the augmented metrology tool and a pipeline, in accordance with some embodiments. Illustrated in FIG. 32A is the augmented metrology tool and the user interfaces discussed herein that may be supported by a web frontend. The web frontend may be supported by a plurality of backend tools such as database management tools such as MongoDB® and/or Amazon® S3, image processing tools such as IMGProxy, and a dataflow automation tool such as Prefect®. The web frontend may interface with one or more of these tools using an application programming interface (API). Illustrated in FIG. 32B is an example high-level view of a pipeline of the present disclosure. The pipeline may receive data or metrics from processes such as data or metrics from SEM images. The data or metrics may be transmitted or received by APIs configured to transmit or receive data or metrics. The pipeline may process the data or metrics using one or more processes, e.g., operation 1, 2, and so forth. Processes may include, for example, preprocessing operations e.g., data loader, noise removal, or SEM denoiser. Processes may include, for example, metrology operations, e.g., image alignment, object recognition, or metric extraction. Processes may include, for example, semiconductor metric operations (SEMetric), e.g., evaluation, build asset, or deployment. Processes may include, for example, processes associated with analysis modules configured to use machine learning methods to generate additional metrics or improved metrics that increase yield. Data or metrics from the pipeline may be transmitted to one or more GUIs wherein the GUIs are configured to enable users to use, customize, or otherwise further configure the data or metrics.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Machine Learning

In some embodiments, machine learning algorithms are utilized to aid in determining or generating recommendations for metrics. In some embodiments, the machine learning algorithm is used to determine or generate recommendations to improve metrics. In some cases, analysis modules described elsewhere herein comprise the machine learning algorithms.

In some embodiments, the machine learning algorithms utilized by analysis modules employ one or more forms of labels including but not limited to human annotated labels and semi-supervised labels. The human annotated labels can be provided by users, e.g., process engineers and the like. The semi-supervised labels can be determined using a clustering technique to find metrics similar to those flagged by previous human annotated labels and previous semi-supervised labels. The semi-supervised labels can employ a XGBoost, a neural network, or both.

In some embodiments, machine learning algorithms are utilized by analysis modules to determine a probability that a metric is a good metric or an improved metric compared to previously identified metrics. In some cases, analysis modules may determine probabilities by analyzing a distribution or correlation with a yield among hundreds of metrics, both within and between images and datasets.

Examples of machine learning algorithms can include a support vector machine (SVM), a naïve Bayes classification, a random forest, a neural network, deep learning, or other supervised learning algorithm or unsupervised learning algorithm for classification and regression. The machine learning algorithms can be trained using one or more training datasets.

In some embodiments, a machine learning algorithm is used to select metrics and recommend improvements to metrics that can increase yield. A non-limiting example of a multi-variate linear regression model algorithm is seen below: probability=A₀+A₁(X₁)+A₂(X₂)+A₃(X₃)+A₄(X₄)+A₅(X₅)+A₆(X₆)+A₇(X₇) . . . wherein Aᵢ (A₁, A₂, A₃, A₄, A₅, A₆, A₇, . . . ) are “weights” or coefficients found during the regression modeling; and Xᵢ (X₁, X₂, X₃, X₄, X₅, X₆, X₇, . . . ) are data collected from the user. Any number of Aᵢ and Xᵢ variable can be included in the model.

In some embodiments, training comprises multiple operations. In a first operation, an initial model is constructed by assigning probability weights to predictor metrics or data. In a second operation, the initial model is used to “recommend” initial metrics. In a third step, the validation module accepts verified metrics or data and feeds back the verified metrics or data to the metric probability generation. At least one of the first operation, the second operation, and the third operation can repeat one or more times continuously or at set intervals.

In some embodiments, machine learning algorithms are utilized to aid in determining or predicting a user's preferred metrics.

### Computing System

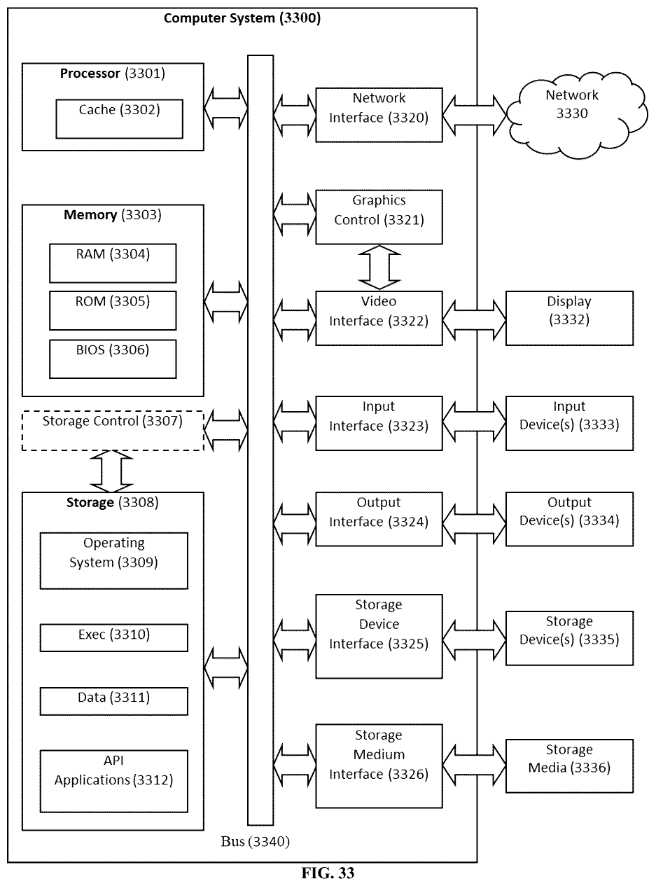

Referring to FIG. 33, a block diagram is shown depicting an exemplary machine that includes a computer system 3300 (e.g., a processing or computing system) within which a set of instructions can execute for causing a device to perform or execute any one or more of the aspects and/or methodologies for the platform of the present disclosure. The components in FIG. 33 are examples only and do not limit the scope of use or functionality of any hardware, software, embedded logic component, or a combination of two or more such components implementing particular embodiments.

Computer system 3300 may include one or more processors 3301, a memory 3303, and a storage 3308 that communicate with each other, and with other components, via a bus 3340. The bus 3340 may also link a display 3332, one or more input devices 3333 (which may, for example, include a keypad, a keyboard, a mouse, a stylus, etc.), one or more output devices 3334, one or more storage devices 3335, and various tangible storage media 3336. All of these elements may interface directly or via one or more interfaces or adaptors to the bus 3340. For instance, the various tangible storage media 3336 can interface with the bus 3340 via storage medium interface 3326. Computer system 3300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 3300 includes one or more processor(s) 3301 (e.g., central processing units (CPUs) or general purpose graphics processing units (GPGPUs)) that carry out functions. Processor(s) 3301 optionally contains a cache memory unit 3302 for temporary local storage of instructions, data, or computer addresses. Processor(s) 3301 are configured to assist in execution of computer readable instructions. Computer system 3300 may provide functionality for the components depicted in FIG. 33 as a result of the processor(s) 3301 executing non-transitory, processor-executable instructions embodied in one or more tangible computer-readable storage media, such as memory 3303, storage 3308, storage devices 3335, and/or storage medium 3336. The computer-readable media may store software that implements particular embodiments, and processor(s) 3301 may execute the software. Memory 3303 may read the software from one or more other computer-readable media (such as mass storage device(s) 3335, 3336) or from one or more other sources through a suitable interface, such as network interface 3320. The software may cause processor(s) 3301 to carry out one or more processes or one or more steps of one or more processes described or illustrated herein. Carrying out such processes or steps may include defining data structures stored in memory 3303 and modifying the data structures as directed by the software.

The memory 3303 may include various components (e.g., machine readable media) including, but not limited to, a random access memory component (e.g., RAM 3304) (e.g., static RAM (SRAM), dynamic RAM (DRAM), ferroelectric random access memory (FRAM), phase-change random access memory (PRAM), etc.), a read-only memory component (e.g., ROM 3305), and any combinations thereof. ROM 3305 may act to communicate data and instructions unidirectionally to processor(s) 3301, and RAM 3304 may act to communicate data and instructions bidirectionally with processor(s) 3301. ROM 3305 and RAM 3304 may include any suitable tangible computer-readable media described below. In one example, a basic input/output system 3306 (BIOS), including basic routines that help to transfer information between elements within computer system 3300, such as during start-up, may be stored in the memory 3303.

Fixed storage 3308 is connected bidirectionally to processor(s) 3301, optionally through storage control unit 3307. Fixed storage 3308 provides additional data storage capacity and may also include any suitable tangible computer-readable media described herein. Storage 3308 may be used to store operating system 3309, executable(s) 3310, data 3311, applications 3312 (application programs), and the like. Storage 3308 can also include an optical disk drive, a solid-state memory device (e.g., flash-based systems), or a combination of any of the above. Information in storage 3308 may, in appropriate cases, be incorporated as virtual memory in memory 3303.

In one example, storage device(s) 3335 may be removably interfaced with computer system 3300 (e.g., via an external port connector (not shown)) via a storage device interface 3325. Particularly, storage device(s) 3335 and an associated machine-readable medium may provide non-volatile and/or volatile storage of machine-readable instructions, data structures, program modules, and/or other data for the computer system 3300. In one example, software may reside, completely or partially, within a machine-readable medium on storage device(s) 3335. In another example, software may reside, completely or partially, within processor(s) 3301.

Bus 3340 connects a wide variety of subsystems. Herein, reference to a bus may encompass one or more digital signal lines serving a common function, where appropriate. Bus 3340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 3300 may also include an input device 3333. In one example, a user of computer system 3300 may enter commands and/or other information into computer system 3300 via input device(s) 3333. Examples of an input device(s) 3333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 3333 may be interfaced to bus 3340 via any of a variety of input interfaces 3323 (e.g., input interface 3323) including, but not limited to, serial, parallel, game port, USB, FIREWIRE, THUNDERBOLT, or any combination of the above.

In particular embodiments, when computer system 3300 is connected to network 3330, computer system 3300 may communicate with other devices, specifically mobile devices and enterprise systems, distributed computing systems, cloud storage systems, cloud computing systems, and the like, connected to network 3330. Communications to and from computer system 3300 may be sent through network interface 3320. For example, network interface 3320 may receive incoming communications (such as requests or responses from other devices) in the form of one or more packets (such as Internet Protocol (IP) packets) from network 3330, and computer system 3300 may store the incoming communications in memory 3303 for processing. Computer system 3300 may similarly store outgoing communications (such as requests or responses to other devices) in the form of one or more packets in memory 3303 and communicated to network 3330 from network interface 3320. Processor(s) 3301 may access these communication packets stored in memory 3303 for processing.

Examples of the network interface 3320 include, but are not limited to, a network interface card, a modem, and any combination thereof. Examples of a network 3330 or network segment 3330 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 3330, may employ a wired and/or a wireless mode of communication. In general, any network topology may be used.

Information and data can be displayed through a display 3332. Examples of a display 3332 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 3332 can interface to the processor(s) 3301, memory 3303, and fixed storage 3308, as well as other devices, such as input device(s) 3333, via the bus 3340. The display 3332 is linked to the bus 3340 via a video interface 3322, and transport of data between the display 3332 and the bus 3340 can be controlled via the graphics control 3321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 3332, computer system 3300 may include one or more other peripheral output devices 3334 including, but not limited to, an audio speaker, a printer, a storage device, and any combinations thereof. Such peripheral output devices may be connected to the bus 3340 via an output interface 3324. Examples of an output interface 3324 include, but are not limited to, a serial port, a parallel connection, a USB port, a FIREWIRE port, a THUNDERBOLT port, and any combinations thereof.

In addition or as an alternative, computer system 3300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

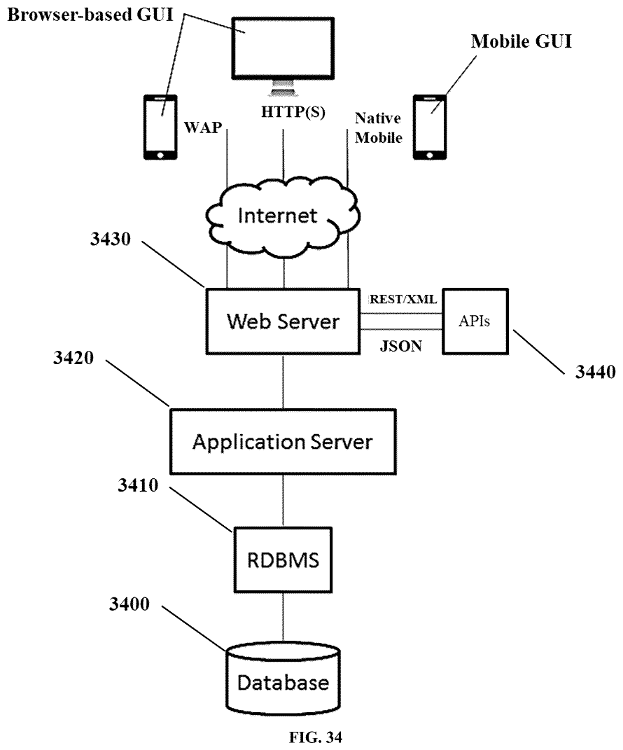

Referring to FIG. 34, in a particular embodiment, an application provision system comprises one or more databases 3400 accessed by a relational database management system (RDBMS) 3410. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 3420 (such as Java servers, .NET servers, PHP servers, and the like) and one or more web servers 3430 (such as Apache, IIS, GWS and the like). The web server(s) optionally expose one or more web services via app application programming interfaces (APIs) 3440. Via a network, such as the Internet, the system provides browser-based and/or mobile native user interfaces.

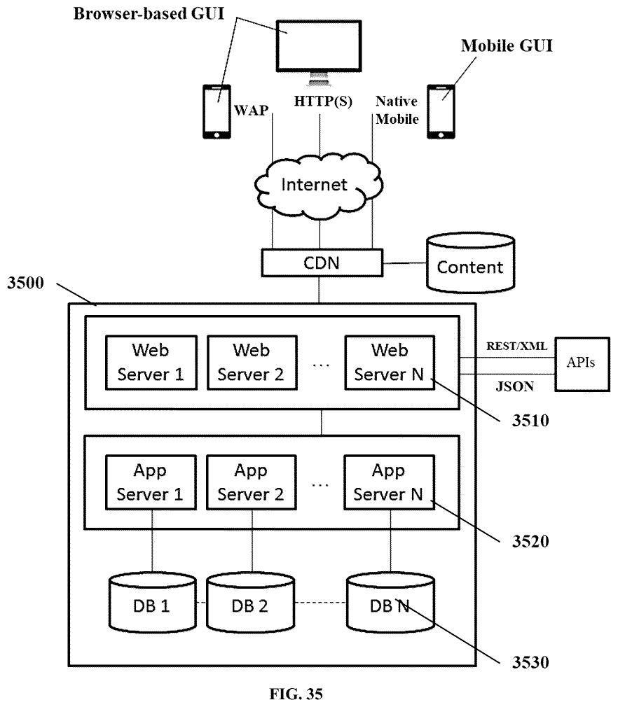

Referring to FIG. 35, in a particular embodiment, an application provision system alternatively has a distributed, cloud-based architecture 3500 and comprises elastically load balanced, auto-scaling web server resources 3510 and application server resources 3520 as well synchronously replicated databases 3530.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques using known hardware, languages, and development environments. Mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung© Apps, and Nintendo® DSi Shop.

### Standalone Application

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins can include, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by using known machines, software, and languages known. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, many databases are suitable for storage and retrieval of metrology or image information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

1.-53. (canceled)

54. A metrology platform comprising:
a customizable or user-configurable pipeline that is configured to enable a user to automatically and longitudinally obtain a plurality of metrology metrics from a process environment; and
a graphical user interface (GUI) for implementing the pipeline, wherein the GUI comprises (1) a plurality of graphical functions configured to permit the user to interact with or to customize the pipeline and (2) one or more visual display areas configured to display the plurality of metrology metrics and a set of metrology images associated thereof.

55. The metrology platform of claim 54, wherein the one or more visual display areas are configured to dynamically update the plurality of metrology metrics and the set of metrology images substantially in real time as the user is interacting with or customizing the pipeline using the plurality of graphical functions.

56. The metrology platform of claim 54, wherein the process environment comprises a semiconductor manufacturing environment.

57. The metrology platform of claim 54, wherein the pipeline is configured to incorporate (1) one or more new processes and/or (2) one or more changes to existing processes that are introduced into the process environment.

58. The metrology platform of claim 54, wherein the GUI is configured to permit the user to define one or more objects of interest from the set of metrology images, and wherein (1) the one or more objects of interest comprise a deposited or fabricated structure that is formed in the process environment and/or (2) the plurality of metrology metrics comprises a plurality of critical dimensions (CDs) of the one or more objects of interest.

59. The metrology platform of claim 54, wherein the pipeline is configured to automatically analyze one or more objects of interest defined by the user through the GUI.

60. The metrology platform of claim 54, wherein the pipeline is configured to dynamically modify a metrology result by tuning one or more measurement methods based at least in part on a set of requirements that the user provides via the GUI.

61. The metrology platform of claim 54, wherein the pipeline is configured to receive an input from the user through the GUI, and wherein the input is used to define one or more objects of interest when an automatic or default definition for the one or more objects is unavailable.

62. The metrology platform of claim 54, wherein the pipeline is configured to automatically (1) derive the plurality of metrics for one or more objects of interest to the user, based at least in part on definitions associated with the one or more objects and (2) modify relationships between the plurality of metrics and one or more objects of interest to the user, without requiring input from the user through the GUI.

63. The metrology platform of claim 54, wherein the GUI is configured to allow the user to (1) add or remove one or more stages to the pipeline and (2) remove or modify one or more hyperparameters in the pipeline.

64. The metrology platform of claim 54, wherein the pipeline comprises a dataflow module configured to manage system input/output (IO) through the GUI, and wherein the GUI comprises a plurality of options that enable the user to connect the user's system to the pipeline.

65. The metrology platform of claim 64, wherein the plurality of options comprises:
a synchronization option configured to define triggering of a workflow in the pipeline, a source option configured to define an input source for the user's system and the pipeline,
a destination option configured to define an output source for the user's system and the pipeline, and
a transformer option configured to specify a modification to data received from the input source before saving modified data to a destination.

66. The metrology platform of claim 54, wherein the GUI comprises a dashboard comprising a plurality of panels that display information about the user's system and the pipeline, and wherein the information comprises a resource status and/or pipeline workflow run successes or failures.

67. The metrology platform of claim 66, wherein the GUI is configured to enable the user to:
modify the dashboard by adding a new panel and/or removing an existing panel, and
enable the user to adjust a size and/or position of one or more panels on the dashboard.

68. The metrology platform of claim 54, further comprising an analysis module configured to analyze a distribution or correlation with yield among the plurality of metrics.

69. The metrology platform of claim 68, wherein the distribution or correlation is analyzed (1) within the set of metrology images and datasets for a single domain within the process environment or (2) between or across multiple sets of metrology images and datasets for multiple domains within the process environment.

70. The metrology platform of claim 68, wherein the analysis module is configured to:
recommend a set of metrics from the plurality of metrics to the user based at least in part on an analysis of the distribution or correlation with yield among the plurality of metrics, and
provide an analysis of a correlation between yield and various levels from individual objects in metrology images to a process within the process environment.

71. The metrology platform of claim 54, further comprising an anomaly analysis module configured to provide anomaly information predicted to impact metrology measurements.

72. The metrology platform of claim 71, wherein the anomaly information comprises (1) object anomalies that indicate a presence and/or transformed state of one or more objects in one or more metrology images and/or (2) one or more types of object anomalies.

73. The metrology platform of claim 72, wherein the anomaly information is provided in a report displayed on the GUI, and wherein the report is useable for analyzing process stability or issues.
